(19) United States
(12) Patent Application Publication
(10) Pub. No.: US 2018/0155658 A1
(43) Pub. Date: Jun. 7, 2018

(54) CLEANING COMPOSITIONS INCLUDING ENZYME AND BLEACH

(71) Applicant: The Procter & Gamble Company, Cincinnati, OH (US)

(72) Inventors: Neil Joseph Lant, Newcastle upon Tyne (GB); Susana Fernandez Prieto, Benicassim (BE)

(21) Appl. No.: 15/827,021

(22) Filed: Nov. 30, 2017

(30) Foreign Application Priority Data
Dec. 2, 2016 (EP) 16202071.3
Dec. 2, 2016 (EP) 16202072.1
Dec. 2, 2016 (EP) 16202073.9
Dec. 2, 2016 (EP) 16202074.7
Dec. 2, 2016 (EP) 16202075.4
Dec. 2, 2016 (EP) 16202076.2
Dec. 2, 2016 (EP) 16202077.0
Dec. 2, 2016 (EP) 16202078.8
Dec. 2, 2016 (EP) 16202079.6
Dec. 2, 2016 (EP) 16202080.4

(51) Int. Cl. C11D 3/386; C11D 3/00; C11D 3/39; C11D 3/382; C11D 3/20

(52) U.S. Cl. CPC C11D 3/38636; C11D 3/0021; C11D 3/2068; C11D 3/3942; C11D 3/382; C11D 3/3917

(57) ABSTRACT

Cleaning compositions that include an extracellular-polymer-degrading enzyme selected from the group consisting of endo-beta-1,6-galactanase enzymes, mannanase enzymes and mixtures thereof, a peroxygen source; and a bleach catalyst and methods of making and using such cleaning compositions to provide stain and soil removal and/or malodour reduction.

### REFERENCE TO A SEQUENCE LISTING

This application contains a Sequence Listing in computer readable form, which is incorporated herein by reference.

### FIELD OF THE INVENTION

The present disclosure relates to cleaning compositions that include an extracellular-polymer-degrading enzyme selected from the group consisting of galactanase enzymes, mannanase enzymes, and mixtures thereof and certain adjunct material(s), such as water-insoluble plant fibers, particular dye control agents, particular alkoxylated phenol compounds, a bleaching system that includes a peroxygen source and an acyl hydrazone bleach catalyst, an amine, or mixtures thereof. The present disclosure also relates to methods of making and using such cleaning compositions. The present disclosure also relates to the uses of such adjunct materials.

### BACKGROUND OF THE INVENTION

The laundry detergent formulator is constantly aiming to improve the performance of detergent compositions. Enzymes may be added to liquid detergent formulations in order to improve cleaning performance, but soils may remain on the targeted surface. A particular challenge is the removal of certain malodorous soils from surfaces such as textiles, especially under more sustainable washing processes involving cool wash temperatures. Even when a soil is lifted from a fabric, the lifted material may redeposit onto the fabric during the wash cycle, impacting whiteness and/or color contrast between white and colored regions on the same fabric. Furthermore, dyes may be released from a fabric into the wash liquor, complex with soils, and inhibit the performance of the cleaning adjuncts.

There is a need for improved cleaning compositions that provide improved benefits, such as soil removal benefits, improved malodor removal benefits, improved whiteness benefits, and/or improved color contrast benefits.

### SUMMARY OF THE INVENTION

The present disclosure relates to cleaning compositions that include an extracellular-polymer-degrading enzyme selected from the group consisting of galactanase enzymes, mannanase enzymes, and mixtures thereof. For example, the present disclosure relates to a cleaning composition that includes an extracellular-polymer-degrading enzyme selected from the group consisting of galactanase enzymes, mannanase enzymes, and mixtures thereof and an adjunct material selected from the group consisting of: (a) from about 0.01% to about 5%, by weight of the cleaning composition, of water-insoluble plant fiber; (b) a dye control agent selected from the group consisting of: (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazine monomer compounds; and (vi) combinations thereof; (c) an alkoxylated phenol compound that is selected from the group consisting of an alkoxylated polyaryl phenol compound, an alkoxylated polyalkyl phenol compound, and mixtures thereof; (d) a bleaching system comprising a peroxygen source and an acyl hydrazone bleach catalyst; (e) an amine; and (f) mixtures thereof.

The present disclosure also relates to a method of cleaning a surface, preferably a textile, where the method includes the step of mixing a cleaning composition as described herein with water to form an aqueous liquor and contacting a surface, preferably a textile, with the aqueous liquor in a laundering step.

The present disclosure also relates to uses of an adjunct material in a cleaning composition to enhance the stain-removal, bleaching, whiteness, and/or malodor-reducing benefits of an extracellular-polymer-degrading enzyme selected from the group consisting of galactanase enzymes, mannanase enzymes, and mixtures thereof, where the adjunct material is selected from selected from adjunct materials (a)-(f) above.

### DETAILED DESCRIPTION OF THE INVENTION

The present disclosure relates to cleaning compositions, for example liquid cleaning compositions, that include an extracellular-polymer-degrading enzyme selected from the group consisting of galactanase enzymes, mannanase enzymes, and mixtures thereof and certain adjunct material(s). The adjunct materials may include water-insoluble plant fibers, particular dye control agents, particular alkoxylated phenol compounds, a bleaching system that includes a peroxygen source and an acyl hydrazone bleach catalyst, an amine, or mixtures thereof. It is believed that the extracellular-polymer-degrading enzyme and the selected adjunct materials may work synergistically to provide one or more of the benefits described herein.

The components of the compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present invention can comprise, consist essentially of, or consist of, the components of the present invention.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the term “etheramine” includes the term “polyetheramine” and includes amines that have one or more ether groups.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the term “alkoxy” is intended to include C1-C8 alkoxy and C1-C8 alkoxy derivatives of polyols having repeating units such as butylene oxide, glycidol oxide, ethylene oxide or propylene oxide.

As used herein, unless otherwise specified, the terms “alkyl” and “alkyl capped” are intended to include C1-C18 alkyl groups, or even C1-C6 alkyl groups.

As used herein, unless otherwise specified, the term “aryl” is intended to include C3-12 aryl groups.

As used herein, unless otherwise specified, the term “arylalkyl” and “alkaryl” are equivalent and are each intended to include groups comprising an alkyl moiety bound to an aromatic moiety, typically having C1-C18 alkyl groups and, in one aspect, C1-C6 alkyl groups.

The terms “ethylene oxide,” “propylene oxide” and “butylene oxide” may be shown herein by their typical designation of “EO,” “PO” and “BO,” respectively.

As used herein, the term “cleaning and/or treatment composition” includes, unless otherwise indicated, granular, powder, liquid, gel, paste, unit dose, bar form and/or flake type washing agents and/or fabric treatment compositions, including but not limited to products for laundering fabrics, fabric softening compositions, fabric enhancing compositions, fabric freshening compositions, and other products for the care and maintenance of fabrics, and combinations thereof. Such compositions may be pre-treatment compositions for use prior to a washing step or may be rinse added compositions, as well as cleaning auxiliaries, such as bleach additives and/or “stain-stick” or pre-treat compositions or substrate-laden products such as dryer added sheets.

As used herein, “cellulosic substrates” are intended to include any substrate which comprises cellulose, either 100% by weight cellulose or at least 20% by weight, or at least 30% by weight or at least 40% or at least 50% by weight or even at least 60% by weight cellulose. Cellulose may be found in wood, cotton, linen, jute, and hemp. Cellulosic substrates may be in the form of powders, fibers, pulp and articles formed from powders, fibers and pulp. Cellulosic fibers, include, without limitation, cotton, rayon (regenerated cellulose), acetate (cellulose acetate), triacetate (cellulose triacetate), and mixtures thereof. Typically, cellulosic substrates comprise cotton. Articles formed from cellulosic fibers include textile articles such as fabrics. Articles formed from pulp include paper.

As used herein, the term “maximum extinction coefficient” is intended to describe the molar extinction coefficient at the wavelength of maximum absorption (also referred to herein as the maximum wavelength), in the range of 400 nanometers to 750 nanometers.

As used herein “average molecular weight” is reported as a weight average molecular weight, as determined by its molecular weight distribution; as a consequence of their manufacturing process, polymers disclosed herein may contain a distribution of repeating units in their polymeric moiety.

As used herein the term “variant” refers to a polypeptide that contains an amino acid sequence that differs from a wild type or reference sequence. A variant polypeptide can differ from the wild type or reference sequence due to a deletion, insertion, or substitution of a nucleotide(s) relative to said reference or wild type nucleotide sequence. The reference or wild type sequence can be a full-length native polypeptide sequence or any other fragment of a full-length polypeptide sequence. A polypeptide variant generally has at least about 70% amino acid sequence identity with the reference sequence, but may include 75% amino acid sequence identity within the reference sequence, 80% amino acid sequence identity within the reference sequence, 85% amino acid sequence identity with the reference sequence, 86% amino acid sequence identity with the reference sequence, 87% amino acid sequence identity with the reference sequence, 88% amino acid sequence identity with the reference sequence, 89% amino acid sequence identity with the reference sequence, 90% amino acid sequence identity with the reference sequence, 91% amino acid sequence identity with the reference sequence, 92% amino acid sequence identity with the reference sequence, 93% amino acid sequence identity with the reference sequence, 94% amino acid sequence identity with the reference sequence, 95% amino acid sequence identity with the reference sequence, 96% amino acid sequence identity with the reference sequence, 97% amino acid sequence identity with the reference sequence, 98% amino acid sequence identity with the reference sequence, 98.5% amino acid sequence identity with the reference sequence or 99% amino acid sequence identity with the reference sequence.

As used herein, the term “solid” includes granular, powder, bar and tablet product forms.

As used herein, the term “fluid” includes liquid, gel, paste, and gas product forms.

### Cleaning Composition

The present disclosure relates to cleaning and/or treatment compositions. The cleaning composition may be selected from the group of light duty liquid detergents compositions, heavy duty liquid detergent compositions, solid, for example particulate/powder or “dry” cleaning compositions, hard surface cleaning compositions, detergent gels commonly used for laundry, bleaching compositions, laundry additives, fabric enhancer compositions, shampoos, body washes, other personal care compositions, and mixtures thereof. The cleaning composition may be a hard surface cleaning composition (such as a dishwashing composition) or a laundry composition (such as a heavy-duty liquid or solid detergent composition).

The cleaning compositions may be in any suitable form. The composition can be selected from a liquid, solid, or combination thereof. As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids. A “solid” as used herein includes, but is not limited to, powders, agglomerates, and mixtures thereof. Non-limiting examples of solids include: granules, micro-capsules, beads, noodles, and pearlised balls. Solid compositions may provide a technical benefit including, but not limited to, through-the-wash benefits, pre-treatment benefits, and/or aesthetic effects.

The cleaning composition may be in the form of a unitized dose article, such as a tablet or in the form of a pouch. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch may be liquid, solid (such as powders), or combinations thereof.

### Extracellular-Polymer-Degrading Enzyme

Galactanase Enzyme

The endo-beta-1,6-galactanase enzyme is an extracellular polymer-degrading enzyme. The term “endo-beta-1,6-galactanase” or “a polypeptide having endo-beta-1,6-galactanase activity” means an endo-beta-1,6-galactanase activity (EC 3.2.1.164) that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals.

Preferably the galactanase enzyme is selected from Glycoside Hydrolase (GH) Family 30.

Preferably, the endo-beta-1,6-galactanase comprises a microbial enzyme. The endo-beta-1,6-galactanase may be fungal or bacterial in origin. Bacterial endo-beta-1,6-galactanase may be most preferred. Fungal endo-beta-1,6-galactanase may be most preferred.

A bacterial endo-beta-1,6-galactanase is obtainable from Streptomyces, for example Streptomyces davawensis. A preferred endo-beta-1,6-galactanase is obtainable from Streptomyces davawensis JCM 4913 defined in SEQ ID NO: 1 herein, or a variant thereof, for example having at least 40% or 50% or 60% or 70% or 75% or 80% or 85% or 90% or 95%, 96%, 97%, 98%, 99% or 100% identity thereto.

Other bacterial endo-beta-1,6-galactanase include those encoded by the DNA sequences of Streptomyces avermitilis MA-4680 defined in SEQ ID NO: 2 herein, or a variant thereof, for example having at least 40% or 50% or 60% or 70% or 75% or 80% or 85% or 90% or 95%, 96%, 97%, 98%, 99% or 100% identity thereto.

A fungal endo-beta-1,6-galactanase is obtainable from Trichoderma, for example Trichoderma harzianum. A preferred endo-beta-1,6-galactanase is obtainable from Trichoderma harzianum defined in SEQ ID NO: 3 herein, or a variant thereof, for example having at least 40% or 50% or 60% or 70% or 75% or 80% or 85% or 90% or 95%, 96%, 97%, 98%, 99% or 100% identical thereto.

Other fungal endo-beta-1,6-galactanases include those encoded by the DNA sequences of Ceratocystis fimbriata f. sp. Platani, Muscodor strobelii WG-2009a, Oculimacula yallundae, Trichoderma viride GD36A, Thermomyces stellatus, Myceliophthora thermophilia.

Preferably the galactanase has an amino acid sequence having at least 60%, or at least 80%, or at least 90% or at least 95% identity with the amino acid sequence shown in SEQ ID NO:1, SEQ ID NO:2 or SEQ ID NO:3.

Preferably the galactanase is an isolated galactanase.

Preferably the galactanase enzyme is present in a laundering aqueous solution in an amount of from 0.01 ppm to 1000 ppm of the galactanase enzyme, or from 0.05 or from 0.1 ppm to 750 or 500 ppm.

The galactanases may also give rise to biofilm-disrupting effects.

Mannanase Enzyme

The mannanase enzyme is an extracellular polymer-degrading enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and β-D-mannanase. Preferred mannanases are members of the glycoside hydrolase family 26.

Preferred mannanases are variants having at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 4 from Ascobolus stictoideus;

Preferred mannanases are variants having at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 5 from Chaetomium virescens.

Preferred mannanases are variants having at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 6 from Preussia aemulans.

Preferred mannanases are variants having at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 7 from Yunnania penicillata.

Preferred mannanases are variants having at least at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 8 from Myrothecium roridum.

Preferably the mannanase is an isolated mannanase.

Preferably the mannanase enzyme is present in the cleaning compositions in an amount from 0.001 to 1 wt % based on active protein in the composition, or from 0.005 to 0.5 wt % or from 0.01 to 0.25 wt %. Preferably the mannanase enzyme is present in the laundering aqueous liquor in an amount of from 0.01 ppm to 1000 ppm of the mannanase enzyme, or from 0.05 or from 0.1 ppm to 750 or 500 ppm.

The mannanases may also give rise to biofilm-disrupting effects.

### Water-Insoluble Plant Fiber

The liquid cleaning compositions of the present disclosure may include water-soluble plant fiber. Without wishing to be bound by theory, it is believed that the water-insoluble plant fibers result in microabrasion of a target surface, such as a soiled fabric, thereby complementing the cleaning mechanism of the extracellular-polymer-degrading enzyme and enhancing the removal of the soil matrix. This effect may be particularly strong in instances of direct application of a neat liquid detergent onto the fabric surface, such as in a pretreatment process. Additionally, such fibers may be particularly useful in liquid compositions, as they can provide structuring benefits.

The liquid cleaning compositions of the present disclosure may include from about 0.01% to about 5%, by weight of the cleaning composition, of water-insoluble fiber.

The water-insoluble plant fiber may be derived from any member of the plant kingdom, including trees, herbaceous plants and the fruits of these plants. Example sources of such fibers are wood, chicory root, sugar beet and citrus or other fruits such as apple. The fibers may be produced as a side-stream from the processing of such crops for other purposes, for example in sugar refining, inulin production and fruit juice production.

Examples of suitable materials include parenchymal cellulose compositions and activated citrus fibers.

Suitable parenchymal cellulose compositions include particulate cellulose material containing, by dry weight of the particulate cellulose material, at least 70% cellulose, less than 10% pectin and at least 3% hemicellulose, wherein the particulate material has a volume-weighted median major particle dimension within the range of 25-75 μm, preferably within the range of 35-65 μm, as measured by laser light diffractometry in accordance with the established protocol ISO13320 (2009). The particulate cellulose material of this disclosure may contain particles of specific structure, shape and size. Typically, the material contains particles having the form of platelets comprising parenchymal cellulose structures or networks. It is preferred that the size distribution of the particulate material falls within certain limits. When the distribution is measured with a laser light scattering particle size analyzer, such as the Malvern Mastersizer or another instrument of equal or better sensitivity, the diameter data is preferably reported as a volume distribution. Thus, the reported median for a population of particles will be volume-weighted, with about one-half of the particles, on a volume basis, having diameters less than the median diameter for the population. Typically, the median major dimension of the particles of the parenchymal cellulose composition is within the range of 25-75 μm. More preferably the median major dimension of the particles of the parenchymal cellulose composition is within the range of 35-65 μm. Typically at least about 90%, on a volume basis, of the particles has a diameter less than about 120 μm, more preferably less than 110 μm, more preferably less than 100 μm. Preferably, the particulate cellulose material has a volume-weighted median minor dimension larger than 0.5 μm, preferably larger than 1 μm.

The parenchymal cellulose is characterized by the fact that the majority of the cellulose material is present in the form of particles that are distinct from the nanofibrilised cellulose described in the prior art in that the cellulose nanofibrils are not substantially unraveled. Preferably, less than 10%, or more preferably less than 1% or less than 0.1% by dry weight of the cellulose within the composition is in the form of nanofibrillated cellulose. This is advantageous as nanofibrillated cellulose negatively affects the redispersability of the material, as indicated herein before. By ‘nanofibrils’ we refer to the fibrils making up the cellulose fibers, typically having a width in the nanometer range (e.g., less than 1 μm) and a length of up to 20 μm. The nomenclature used in the field over the past decades has been somewhat inconsistent in that the terms ‘microfibril’ and ‘nanofibril’ have been used to denote the same material. In the context of this invention, the two terms are deemed to be fully interchangeable.

In accordance with the invention, the plant parenchymal cellulose material has been treated, modified and/or some components may have been removed but the cellulose at no time has been broken down to individual microfibrils, thereby losing the structure of plant cell wall sections. As mentioned before, the cellulose material of this invention has a reduced pectin content, as compared to the parenchymal cell wall material from which it is derived. Removal of some of the pectin is believed to result in enhanced thermal stability. The term “pectin” as used herein refers to a class of plant cell-wall heterogeneous polysaccharides that can be extracted by treatment with acids and chelating agents. Typically, 70-80% of pectin is found as a linear chain of alpha-(1,4)-linked D-galacturonic acid monomers. The smaller RG-I fraction of pectin is comprised of alternating (1-4)-linked galacturonic acid and (1,2)-linked L-rhamnose, with substantial arabinogalactan branching emanating from the L-rhamnose residue. Other monosaccharides, such as D-fucose, D-xylose, apiose, aceric acid, Kdo, Dha, 2-O-methyl-D-fucose, and 2-O-methyl-D-xylose, are found either in the RG-II pectin fraction (<2%), or as minor constituents in the RG-I fraction. Proportions of each of the monosaccharides in relation to D-galacturonic acid vary depending on the individual plant and its micro-environment, the species, and time during the growth cycle. For the same reasons, the homogalacturonan and RG-I fractions can differ widely in their content of methyl esters on GalA residues, and the content of acetyl residue esters on the C-2 and C-3 positions of GalA and neutral sugars. It is preferred that the particulate cellulose material of the invention comprises less than 5 wt. % of pectin, by dry weight of the particulate cellulose material, more preferably less than 2.5 wt. %. The presence of at least some pectin in the cellulose material is nevertheless desired. Without wishing to be bound by any theory it is assumed that pectin plays a role in the electrostatic interactions between particles contained in the material and/or in supporting the network/structure of the cellulose. Hence, it is preferred that the particulate cellulose material contains at least 0.5 wt % of pectin by dry weight of the particulate cellulose material, more preferably at least 1 wt. %.

Suitable activated citrus fruits may be produced from lemons and limes. These fruits may be de-juiced to leave an insoluble plant cell wall material with some internally contained sugars and pectin. The ‘spongy microstructure’, known as albedo, may be used to make acidic, powdered citrus fiber. The structure is dried, sieved and then washed to increase the fiber content. Dried materials are typically large (with cell fragments greater than 100 microns), consisting of tightly bound/bonded fibrils). After milling a powdered citrus fiber material is obtained. This procedure leaves much of the natural cell wall intact whilst sugars are removed. The resultant swellable citrus fiber materials are typically used as food additives and are often employed for example in low fat mayonnaise.

A preferred type of powdered citrus fiber for detergent formulations and used in accordance with the present invention is available from Herbafood Ingredients GmbH under the tradename, Herbacel™ AQ+ type N citrus fiber. This citrus fiber has a total (soluble and insoluble) fiber content of greater than 80% by weight and soluble fiber content of greater than 20% by weight. It is supplied as a fine dried powder with low colour and has a water binding capacity of about 20 kg water per kg of powder.

The citrus fiber of the present disclosure may be activated citrus fiber. To activate the citrus fibers, powdered citrus fiber may be activated (hydrated and opened up structurally) by using a high shear dispersion process at low concentration, in water. It is also advantageous to include a preservative into the premix as the dispersed activated citrus fiber is biodegradable.

### Dye Control Agent

The cleaning compositions of the present disclosure may comprise a dye control agent. Without wishing to be bound by theory, it is believed that the dye transfer agents inhibit interaction between dyes in the wash liquor and certain soils such as extracellular DNA that are substrates for the extracellular-polymer-degrading enzyme, thereby leading to decreased dye redeposition and increased enzyme performance. Additionally, DNA-based soil material can have particularly adhesive properties and may attract other soils; therefore, efficient extracellular-polymer-degrading enzyme activity can help reduce soil redeposition, whiteness losses, and/or dinginess. This combination of reduced dye transfer and enhanced detergency leads to surprisingly high levels of textile cleanliness and contrast between white and colored regions of textiles.

The dye control agent may be present in the composition at a level of from about 0.02% to about 1%, or from about 0.05% to about 0.5%, by weight of the cleaning composition.

The dye control agent may be selected from the group consisting of: (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazine monomer compounds; and (vi) combinations thereof. These dye control agents are described in more detail below.

(i) Sulfonated Phenol/Formaldehyde Polymer

The dye control agent may comprise a sulfonated phenol/formaldehyde polymer. The sulfonated phenol/formaldehyde polymer may be selected from the product of the condensation of formaldehyde with phenol, cresols, xylenols, nonyl phenol, octyl phenol, butylphenol, phenylphenol, 2,2-bis-4-hydroxyphenylpropane, anisole, resorcinol, bisphenol A, 4,4′-, 2,2′- or 4,2′-dihydroxydiphenyl ether, phenolsulfonic acid, anisole sulfonic acid, dioxydiphenylsulfone, 4-hydroxydiphenylsulfone, naphthol or naphtholsulfonic acid. Suitable examples include Suparex® O.IN (M1), Nylofixan® P (M2), Nylofixan® PM (M3), and Nylofixan® HF (M4) (all supplied by Archroma, Reinach, Switzerland).

(ii) Urea Derivative

The dye control agent may comprise a urea derivative. The urea derivative may have a structure according to Formula I.

(A)ₖAr—NH—C(O)—NH—Ar(A)ₗ-NH[—C(O)—NH-L-NH—C(O)—NH—Ar(A)ₘNH]ₙ—C(O)—NH—Ar(A)ₖ Formula I

in which

Ar denotes an aromatic group, a stilbene group, or a linear, branched, or cyclic, saturated or once or several times ethylenically unsaturated hydrocarbon group with 1 to 12 carbon atoms;

L denotes an arylene or stilbene group;

A denotes —SO₃M or —CO₂M;

M denotes H or an alkali metal atom;

k and m irrespective of each other denote 0, 1, 2 or 3, and l+m≥1;

n denotes a number of from 1 to 6.

Suitable examples of urea derivatives include compounds according to Formulas II and

III, below.

Formula II is below, in which Ph is a phenyl group, n is 1, 2, 3 or 4, the substituents —SO₃H are in ortho position, and the substituents —CH₃ is in ortho position:

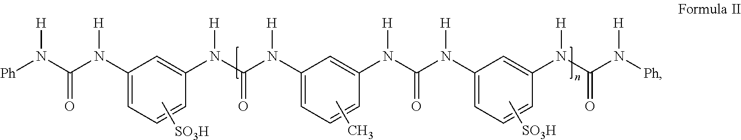

Formula III is below, in which Ph is a phenyl group, n is 1, 2, 3, or 4, the substituents —SO₃H are in ortho positions, and the substituent —CH₃ is in ortho position:

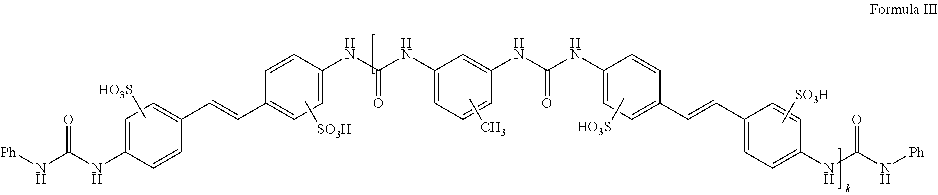

(iii) Polymers of Ethylenically Unsaturated Monomers, where the Polymers are Molecularly Imprinted with Dye

The dye control agent may comprise polymers of ethylenically unsaturated monomers, where the polymers are molecularly imprinted with dye. Methods of producing the molecular imprinted dyes are given in G. Z. Kyzas et al, Chemical Engineering Journal, Volume 149, Issues 1-3, 1 Jul. 2009, Pages 263-272.

One illustrative polymer can be synthesized as follows: 4.05 g (20 mmol) of ethylene glycol monomethacrylate, 0.34 g (4 mmol) of methacrylic acid, and 2.18 g (3.2 mmol) of disodium-8-anilino-5-[[4-[(3-sulfonatophenyl)diazenyl]naphthalen-1-yl]diazenyl]naphthalene-1-sulfonate (Acid Blue 113) in 100 mL of dimethylformamide are charged under a nitrogen atmosphere and stirred for 2 hours at room temperature. Next, 22 mg of azoisobutyronitrile is added; the reaction mixture is degassed for 15 minutes in the ultrasonic bath and is stirred for 12 hours at 75° C. The residue is separated, is washed with acetone and hot water, and is extracted with 500 mL of methanol in a Soxhlet extractor for 8 hours. After drying, 3.5 g of a brittle, dark purple product is obtained.

(iv) Fibers Consisting of Water-Insoluble Polyamide

The dye control agent may comprise fibers consisting of water-insoluble polyamide. The average diameter of the fibers may be not more than 2 μm. Exemplary water-insoluble polyamides fibers include those produced from polyamide-6 and/or polyamide 6,6. The average fiber diameter can be measured by Scanning Electron Microscopy in conjunction with suitable image analysis software, for example the FiberMetric® fiber measurement software supplied by Phenom-World B.V., Eindhoven, The Netherlands.

(v) Polymer Obtainable from Polymerizing Benzoxazine Monomer Compounds

The dye control agent may comprise a polymer obtainable from polymerizing benzoxazine monomer compounds. The polymer obtainable from polymerizing benzoxazine monomer compounds may be selected from Formula IV, Formula V, or mixtures thereof:

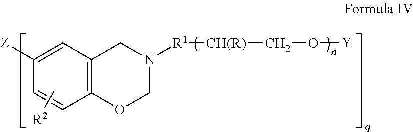

wherein for Formula IV and Formula V:

q is a whole number from 1 to 4,

n is a number from 2 to 20 000,

R in each repeat unit is selected independently of each other from hydrogen or linear or branched, optionally substituted alkyl groups that comprise 1 to 8 carbon atoms,

Z is selected from hydrogen (for q=1), alkyl (for q=1), alkylene (for q=2 to 4), carbonyl (for q=2), oxygen (for q=2), sulfur (for q=2), sulfoxide (for q=2), sulfone (for q=2) and a direct, covalent bond (for q=2),

R¹ stands for a covalent bond or a divalent linking group that contains 1 to 100 carbon atoms,

R² is selected from hydrogen, halogen, alkyl, alkenyl, and/or a divalent group that makes a corresponding naphthoxazine structure from the benzoxazine structure,

Y is selected from linear or branched, optionally substituted, alkyl groups that contain 1 to 15 carbon atoms, cycloaliphatic groups that optionally comprise one or more heteroatoms, aryl groups that optionally comprise one or more heteroatoms, and —(C═O)R₃, wherein R₃ is selected from linear or branched, optionally substituted, alkyl groups containing 1 to 15 carbon atoms and X—R₄, wherein X is selected from S, O, and NH and R₄ is selected from linear or branched, optionally substituted, alkyl groups containing 1 to 15 carbon atoms,

c is a whole number from 1 to 4,

B is selected from hydrogen (for c=1), alkyl (for c=1), alkylene (for c=2 to 4), carbonyl (for c=2), oxygen (for c=2), sulfur (for c=2), sulfoxide (for c=2), sulfone (for c=2) and a direct, covalent bond (for c=2), A is a hydroxyl group or a nitrogen-containing heterocycle,

R⁵ is selected from hydrogen, halogen, alkyl and alkenyl, or R⁵ is a divalent group that makes a corresponding naphthoxazine structure from the benzoxazine structure, and

R⁶ stands for a covalent bond or is a divalent linking group that contains 1 to 100 carbon atoms.

The polymer obtainable from polymerizing benzoxazine monomer compounds may be a compound according to Formula VI:

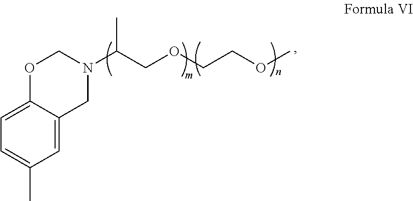

wherein typically, m=35, and wherein n=6.

The compound according to Formula VI may be produced by adding a solution of 16.22 p-cresol in 50 ml ethyl acetate dropwise over a period of 10 minutes to a solution of 9.38 g paraformaldehyde (96% conc.) in 50 ml ethyl acetate. 309.9 g Jeffamin M2070 (Huntsman, EO/PO ratio 10:31) in 200 ml ethyl acetate was then added over a period of 30 minutes, the temperature being maintained below 10° C. After stirring for 10 minutes, the reaction mixture was heated under reflux for 6 h. After cooling, the reaction mixture was filtered and the solvent together with any formed water were removed under vacuum. 318.90 g of the corresponding polymerisable benzoxazine compound was obtained.

### Alkoxylated Phenol Compound

The cleaning compositions of the present disclosure include an alkoxylated phenol compound. Without wishing to be bound by theory, it is believed that the extracellular-polymer-degrading enzymes are active on extracellular DNA materials that adhere to, and cause other soils to adhere to, fabric. It is further believed that the alkoxylated phenols described herein work synergistically with the extracellular-polymer-degrading enzymes to assist in the removal of extracellular DNA-bound soils and prevent re-deposition of the reaction products arising from the action of the extracellular-polymer-degrading enzymes. In doing so, it is believed that the activity of the enzyme on the textile surface is enhanced by reduced interference or inhibition from redeposited soils.

The alkoxylated phenol compound may be present in the cleaning composition at a level of from about 0.2% to about 10%, or from about 0.5% to about 5%, by weight of the cleaning composition.

The alkoxylated phenol compound may be selected from the group consisting of an alkoxylated polyaryl phenol compound, an alkoxylated polyalkyl phenol compound, and mixtures thereof. The alkoxylated phenol compound may be an alkoxylated polyaryl phenol compound. The alkoxylated phenol compound may be an alkoxylated polyalkyl phenol compound.

The alkoxylated phenol compound may have a weight average molecular weight between 280 and 2880.

The alkoxylated phenol compound may have the following structure:

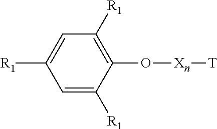

wherein each R₁ is independently selected from linear of branched C3-C15 alkyl groups and aryl groups, X is selected from ethoxy or propoxy groups, n is from 2 to 70, T is selected from H, SO₃⁻, COO⁻ and PO₃²⁻, preferably H and SO₃⁻. Each R₁ may be the same.

The alkoxylated polyaryl or alkoxylated polyalkyl phenol compound is preferably selected from groups (i) to (v):

(i) Uncharged alkoxylated tristyrylphenols of the following structure:

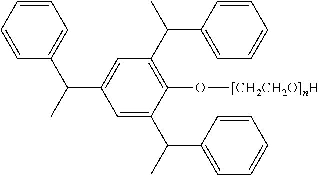

wherein n is selected from 2 to 70, more preferably n is selected from 10 to 54, most preferably n=16 or 20;
(ii) Anionic alkoxylated tristyrylphenols of the following structure

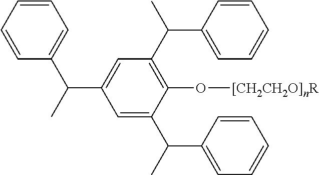

wherein R is selected from SO₃⁻, COO⁻ and PO₃²⁻, preferably selected from SO₃⁻ and COO⁻, wherein n is selected from 2 to 54;
(iii) Uncharged alkoxylated tri(n-butyl)phenols of the following structure:

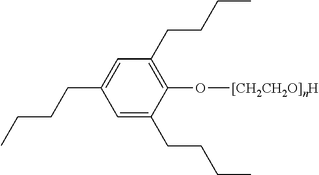

wherein n is selected from 2 to 50;
(iv) Anionic alkoxylated tri(n-butyl)phenols of the following structure:

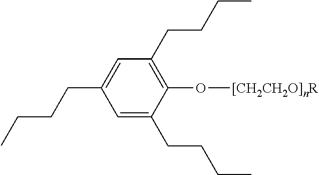

wherein R is selected from SO₃⁻, COO⁻ and PO₃²⁻, preferably selected from SO₃⁻ and COO⁻, wherein n is selected from 6 to 50; and
(v) mixtures thereof.

Such compounds are available from industrial suppliers, for example Solvay under the Soprophor trade name, from Clariant under the Emulsogen trade name, Aoki Oil Industrial Co. under the Blaunon trade name, from Stepan under the Makon trade name, and from TOTO Chemical Industry Co. under the Sorpol trade name

### Bleaching System

The cleaning compositions of the present disclosure may comprise a bleaching system that comprises a peroxygen source and an acyl hydrazone bleach catalyst. Without wishing to be bound by theory, it is believed that the combination of acyl hydrazone bleach catalysts in combination with a peroxygen source synergistically interacts with an extracellular-polymer-degrading enzyme's activity on biofilm to improve soil and/or malodor removal. This might be due to the complementary action of the acyl hydrazone bleach catalyst in killing microorganisms and decolourising certain soil and malodor species, with the action of the extracellular-polymer-degrading enzyme in breaking down extracellular DNA which may play a role in adhering these soil and malodor components to textile surfaces. Certain extracellular-polymer-degrading enzymes may also be surprisingly robust in the presence of the bleach catalyst.

Peroxygen sources and acyl hydrazone bleach catalysts are described in more detail below.

Peroxygen Source

The cleaning compositions and/or bleaching systems of the present disclosure may comprise a peroxygen source. Peroxygen sources are known to provide, for example, bleaching benefits. The peroxygen source may be present in the cleaning composition at a level of from about 0.1% to about 40%, or from about 0.5% to about 20%, by weight of the cleaning composition.

The peroxygen source may be H₂O₂ or a substance that releases H₂O₂ in water. The peroxygen source may be selected from the group consisting of perborates, percarbonates, perhydrates, peroxycarboxylic acids, persulfates, preoxydisulfates, diacyl peroxides, tetraacyl diperoxides, and combinations thereof. The peroxygen source may be selected from the group consisting of alkali metal perborates, alkali metal percarbonates, urea perhydrates, and combination thereof. The peroxygen source may comprises a peroxycarboxylic acid selected from diperoxydecanedicarboxylic acid, phthalimido peroxycaproic acid, or combinations thereof.

Acyl Hydrazone Bleach Catalyst

The cleaning compositions and/or bleaching systems of the present disclosure include an acyl hydrazone bleach catalyst. The acyl hydrazone bleach catalyst may be present in the cleaning composition at a level of from about 0.005% to about 1%, or from about 0.01% to about 0.5%, by weight of the cleaning composition.

The acyl hydrazone bleach catalyst may have a structure according to the general Formula VII:

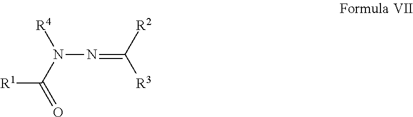

in which R′ stands for a CF₃ or for a C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group, R² and R³ independently of one another stand for hydrogen or an optionally substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group or R² and R³ together with the carbon atom linking them stand for an optionally substituted 5-, 6-, 7-, 8- or 9-membered ring that can optionally comprise heteroatoms, and R⁴ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group.

The acyl hydrazone bleach catalyst may have a structure according to Formula I, wherein R¹ stands for a C₃₋₁₂ cycloheteroalkyl group, R² and R³ independently of one another stand for hydrogen or an optionally substituted phenyl group, and R⁴ stands for hydrogen.

One particularly preferred acyl hydrazone bleach catalyst is 4-(2-(2-((2-hydroxyphenylmethyl)methylene)-hydrazinyl)-2-oxoethyl)-4-methylchloride, shown in Formula VIII below.

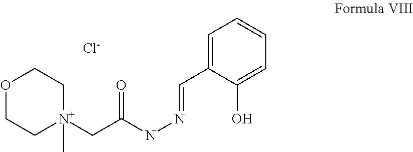 [SMILES: C[N+]1(CC(=O)N/N=C/c2ccccc2O)CCOCC1 ; [Cl-]]

Without wishing to be bound by theory, the acyl hydrazone bleach catalysts described herein boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

### Amines

The cleaning compositions described herein may contain an amine Non-limiting examples of amines include, but are not limited to, etheramines, cyclic amines, polyamines, oligoamines (e.g., triamines, diamines, pentamines, tetraamines), or combinations thereof. Examples of suitable oligoamines include tetraethylenepentamine, triethylenetetraamine, diethylenetriamine, and mixtures thereof. The compositions described herein may comprise an amine selected from the group consisting of oligoamines, etheramines, cyclic amines, and combinations thereof. The cleaning compositions may include from about 0.1% to about 10%, or from about 0.2% to about 5%, or from about 0.5% to about 4%, or from about 0.1% to about 4%, or from about 0.1% to about 2%, by weight of the composition, of an amine. The amine can be subjected to protonation depending on the pH of the cleaning medium in which it is used. Etheramines and cyclic amines are described in more detail below.

Etheramines

The cleaning compositions described herein may contain an etheramine. The cleaning compositions may contain from about 0.1% to about 10%, or from about 0.2% to about 5%, or from about 0.5% to about 4%, by weight of the composition, of an etheramine.

The etheramines of the present disclosure may have a weight average molecular weight of less than about grams/mole 1000 grams/mole, or from about 100 to about 800 grams/mole or from about 200 to about 450 grams/mole, or from about 290 to about 1000 grams/mole, or from about 290 to about 900 grams/mole, or from about 300 to about 700 grams/mole, or from about 300 to about 450 grams/mole. The etheramines of the present invention may have a weight average molecular weight of from about 150, or from about 200, or from about 350, or from about 500 grams/mole to about 1000, or to about 900, or to about 800 grams/mole.

The cleaning compositions may include an etheramine represented by the structure of Formula (I):

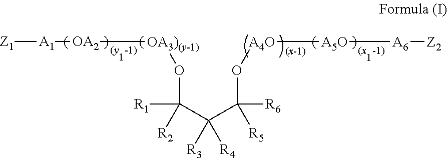

where each of R₁-R₆ is independently selected from H, alkyl, cycloalkyl, aryl, alkylaryl, or arylalkyl, where at least one of R₁-R₆ is different from H, typically at least one of R₁-R₆ is an alkyl group having 2 to 8 carbon atoms, each of A₁-A₆ is independently selected from linear or branched alkylenes having 2 to 18 carbon atoms, each of Z₁-Z₂ is independently selected from OH or NH₂, where at least one of Z₁-Z₂ is NH₂, typically each of Z₁ and Z₂ is NH₂, where the sum of x+y is in the range of about 2 to about 200, or about 2 to about 20, or about 2 to about 10, or about 2 to about 8, or about 3 to about 8, or about 4 to about 6, where x≥1 and y≥1, and the sum of x₁+y₁ is in the range of about 2 to about 200, or about 2 to about 20, or about 2 to about 10, or about 2 to about 8, or about 3 to about 8, or about 2 to about 4, where x₁≥1 and y₁≥1.

Preferably in the etheramine of Formula (I), each of A₁-A₆ is independently selected from ethylene, propylene, or butylene, typically each of A₁-A₆ is propylene. Each of A₁ and A₆ may be independently selected from linear alkanediyl groups having 2 to 18 carbon atoms, preferably 2-10 carbon atoms, most preferably 2-5 carbon atoms; each of A₂, A₃, A₄, and A₅ may be independently selected from linear or branched alkanediyl groups having 2 to 18 carbon atoms, preferably 2-10 carbon atoms, most preferably 2-5 carbon atoms. More preferably, in the etheramine of Formula (I), each of R₁, R₂, R₅, and R₆ is H and each of R₃ and R₄ is independently selected from C1-C16 alkyl or aryl, typically each of R₁, R₂, R₅, and R₆ is H and each of R₃ and R₄ is independently selected from a butyl group, an ethyl group, a methyl group, a propyl group, or a phenyl group. More preferably, in the etheramine of Formula (I), R₃ is an ethyl group, each of R₁, R₂, R₅, and R₆ is H, and R₄ is a butyl group. Especially, in the etheramine of Formula (I), each of R₁ and R₂ is H and each of R₃, R₄, R₅, and R₆ is independently selected from an ethyl group, a methyl group, a propyl group, a butyl group, a phenyl group, or H.

The cleaning compositions described herein may include an etheramine represented by the structure of Formula (II):

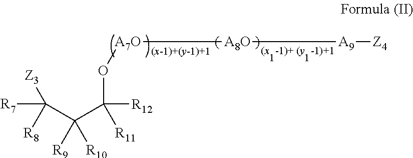

each of R₇-R₁₂ is independently selected from H, alkyl, cycloalkyl, aryl, alkylaryl, or arylalkyl, where at least one of R₇-R₁₂ is different from H, typically at least one of R₇-R₁₂ is an alkyl group having 2 to 8 carbon atoms, each of A₇-A₉ is independently selected from linear or branched alkylenes having 2 to 18 carbon atoms, each of Z₃-Z₄ is independently selected from OH or NH₂, where at least one of Z₃-Z₄ is NH₂, typically each of Z₃ and Z₄ is NH₂, where the sum of x+y is in the range of about 2 to about 200, or about 2 to about 20, or about 2 to about 10, or about 2 to about 8, or about 3 to about 8, or about 2 to about 4, where x≥1 and y≥1, and the sum of x₁+y₁ is in the range of about 2 to about 200, or about 2 to about 20, or about 2 to about 10, or about 2 to about 8, or about 3 to about 8, or about 2 to about 4, where x₁≥1 and y₁≥1.

Preferably in the etheramine of Formula (II), each of A₇-A₉ is independently selected from ethylene, propylene, or butylene, typically each of A₇-A₉ is propylene. A₉ may be selected from linear alkanediyl groups having 2 to 18 carbon atoms, preferably 2-10 carbon atoms, most preferably 2-5 carbon atoms; each of A₇ and A₈ may be independently selected from linear or branched alkanediyl groups having 2 to 18 carbon atoms, preferably 2-10 carbon atoms, most preferably 2-5 carbon atoms. More preferably, in the etheramine of Formula (II), each of R₇, R₈, R₁₁, and R₁₂ is H and each of R₉ and R₁₀ is independently selected from C1-C16 alkyl or aryl, typically each of R₇, R₈, R₁₁, and R₁₂ is H and each of R₉ and R₁₀ is independently selected from a butyl group, an ethyl group, a methyl group, a propyl group, or a phenyl group. More preferably, in the etheramine of Formula (II), R₉ is an ethyl group, each of R₇, R₈, R₁₁, and R₁₂ is H, and R₁₀ is a butyl group. In some aspects, in the etheramine of Formula (II), each of R₇ and R₈ is H and each of R₉, R₁₀, R₁₁, and R₁₂ is independently selected from an ethyl group, a methyl group, a propyl group, a butyl group, a phenyl group, or H.

Suitable etheramines are represented by Formula A, Formula B, and Formula C:

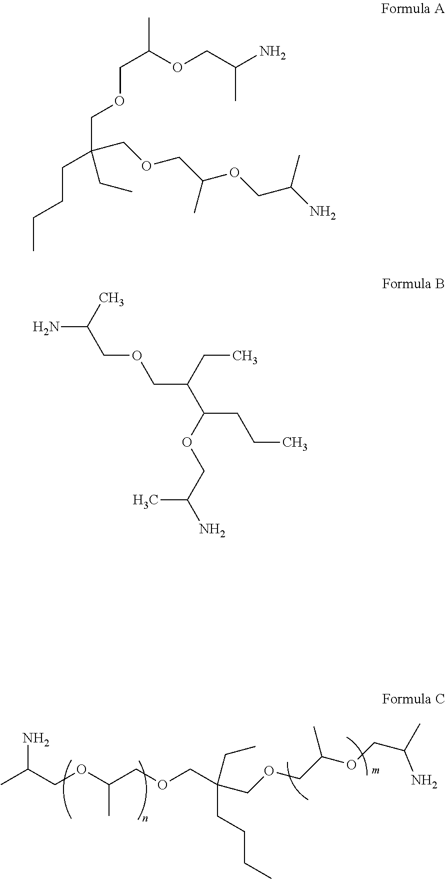

where n+m is from about 0 to about 8, or from about 0 to about 6, or from about 1 to about 6. Preferably, the etheramine comprises a mixture of the compound of Formula (I) and the compound of Formula (II).

Typically, the etheramine of Formula (I) or Formula (II) has a weight average molecular weight of less than about grams/mole 1000 grams/mole, preferably from about 100 to about 900 grams/mole or about 100 to about 800 grams/mole, more preferably from about 200 to about 450 grams/mole.

The etheramine can comprise a etheramine mixture comprising at least 90%, by weight of the etheramine mixture, of the etheramine of Formula (I), the etheramine of Formula (II), the etheramine of Formula (III) or a mixture thereof. Preferably, the etheramine comprises a etheramine mixture comprising at least 95%, by weight of the etheramine mixture, of the etheramine of Formula (I), the etheramine of Formula (II) and the etheramine of Formula (III).

The etheramine of Formula (I) and/or the etheramine of Formula (II) are obtainable by known methods, such as those disclosed in US 2014/0296127A1. The etheramines of Formula (I) and/or Formula (II) may be obtained by:

a) reacting a 1,3-diol of formula (1) with a C₂-C₁₈ alkylene oxide to form an alkoxylated 1,3-diol, wherein the molar ratio of 1,3-diol to C₂-C₁₈ alkylene oxide is in the range of about 1:2 to about 1:10,

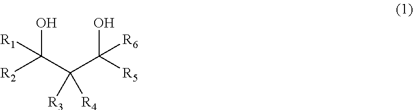

where R₁-R₆ are independently selected from H, alkyl, cycloalkyl, aryl, alkylaryl, or arylalkyl, where at least one of R₁-R₆ is different from H;
b) aminating the alkoxylated 1,3-diol with ammonia.

Suitable 1,3-diols include 2,2-dimethyl-1,3-propane diol, 2-butyl-2-ethyl-1,3-propane diol, 2-pentyl-2-propyl-1,3-propane diol, 2-(2-methyl)butyl-2-propyl-1,3-propane diol, 2,2,4-trimethyl-1,3-propane diol, 2,2-diethyl-1,3-propane diol, 2-methyl-2-propyl-1,3-propane diol, 2-ethyl-1,3-hexane diol, 2-phenyl-2-methyl-1,3-propane diol, 2-methyl-1,3-propane diol, 2-ethyl-2-methyl-1,3 propane diol, 2,2-dibutyl-1,3-propane diol, 2,2-di(2-methylpropyl)-1,3-propane diol, 2-isopropyl-2-methyl-1,3-propane diol, or a mixture thereof. In some aspects, the 1,3-diol is selected from 2-butyl-2-ethyl-1,3-propanediol, 2-methyl-2-propyl-1,3-propanediol, 2-methyl-2-phenyl-1,3-propanediol, or a mixture thereof. Typically used 1,3-diols are 2-butyl-2-ethyl-1,3-propanediol, 2-methyl-2-propyl-1,3-propanediol, 2-methyl-2-phenyl-1,3-propanediol.

The degree of amination for the etheramine of Formula (I) and/or Formula (II) may be from about 50% to about 100%, or from about 60% to about 100%, or from about 70% to about 100%.

The degree of amination may be calculated from the total amine value (AZ) divided by sum of the total acetylables value (AC) and tertiary amine value (tert. AZ) multiplied by 100: (Total AZ/(AC+tert. AZ))×100). The total amine value (AZ) is determined according to DIN 16945. The total acetylables value (AC) is determined according to DIN 53240. The secondary and tertiary amines are determined according to ASTM D2074-07. The hydroxyl value is calculated from (total acetylables value+tertiary amine value)−total amine value.

The cleaning compositions of the present disclosure may contain an etheramine represented by Formula (III),

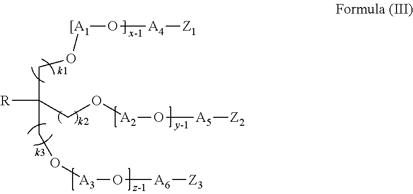

where
R is selected from H or a C1-C6 alkyl group,
each of k₁, k₂, and k₃ is independently selected from 0, 1, 2, 3, 4, 5, or 6,
each of A₁, A₂, A₃, A₄, A₅, and A₆ is independently selected from a linear or branched alkylene group having from about 2 to about 18 carbon atoms or mixtures thereof,
x≥1, y≥1, and z≥1, and the sum of x+y+z is in the range of from about 3 to about 100, and
each of Z₁, Z₂, and Z₃ is independently selected from NH₂ or OH, where at least two of Z₁, Z₂, and Z₃ are NH₂.

Preferably, R is H or a C1-C6 alkyl group selected from methyl, ethyl, or propyl. In some aspects, R is H or a C1-C6 alkyl group selected from ethyl.

Preferably, each of k₁, k₂, and k₃ is independently selected from 0, 1, or 2. Each of k₁, k₂, and k₃ may be independently selected from 0 or 1. More preferably, at least two of k₁, k₂, and k₃ are 1 and even more preferably, each of k₁, k₂, and k₃ is 1.

Preferably, each of Z₁, Z₂, and Z₃ is NH₂.

All A groups (i.e., A i-A₆) may be the same, at least two A groups may be the same, at least two A groups may be different, or all A groups may be different from each other. Each of A₁, A₂, A₃, A₄, A₅, and A₆ may be independently selected from a linear or branched alkylene group having from about 2 to about 10 carbon atoms, or from about 2 to about 6 carbon atoms, or from about 2 to about 4 carbon atoms, or mixtures thereof. Preferably, at least one, or at least three, of A₁-A₆ is a linear or branched butylene group. More preferably, each of A₄, A₅, and A₆ is a linear or branched butylene group. Especially, each of A₁-A₆ is a linear or branched butylene group.

Preferably, x, y, and/or z are independently selected and should be equal to 3 or greater, meaning that that the etheramine may have more than one [A₁-O] group, more than one [A₂-O] group, and/or more than one [A₃-O] group. Preferably, A₁ is selected from ethylene, propylene, butylene, or mixtures thereof. Preferably, A₂ is selected from ethylene, propylene, butylene, or mixtures thereof. Preferably, A₃ is selected from ethylene, propylene, butylene, or mixtures thereof. When A₁, A₂, and/or A₃ are mixtures of ethylene, propylene, and/or butylenes, the resulting alkoxylate may have a block-wise structure or a random structure.

[A₁-O]ₓ₋₁ can be selected from ethylene oxide, propylene oxide, butylene oxide, or mixtures thereof. [A₂-O]_{y-1} can be selected from ethylene oxide, propylene oxide, butylene oxide, or mixtures thereof. [A₃-O]_{z-1} can be selected from ethylene oxide, propylene oxide, butylene oxide, or mixtures thereof.

Preferably, the sum of x+y+z is in the range of from about 3 to about 100, or from about 3 to about 30, or from about 3 to about 10, or from about 5 to about 10.

Preferably, when the etheramine is a etheramine of Formula (III) where R is a C2 alkyl group (i.e., ethyl) and optionally each of k₁, k₂, and k₃ is 1, the molecular weight of the etheramine is from about 500 to about 1000, or to about 900, or to about 800 grams/mole. It is also preferred, when the etheramine is an etheramine of Formula (III) where R is a C2 alkyl group (i.e., ethyl) and optionally each of k₁, k₂, and k₃ is 1, at least one A group (i.e., at least one of A₁, A₂, A₃, A₄, A₅, or A₆) is not a propylene group. It is also preferred, when the etheramine is an etheramine of Formula (III) where R is a C2 alkyl group (i.e., ethyl) and optionally each of k₁, k₂, and k₃ is 1, at least one A group (i.e., at least one of A1, A2, A3, A4, A5, or A6) is a ethylene group or a butylene group, or more typically at least one A group (i.e., at least one of A1, A2, A3, A4, A5, or A6) is a butylene group.

The compositions may include an etheramine selected from the group consisting of Formula D, Formula E, Formula F, and mixtures thereof:

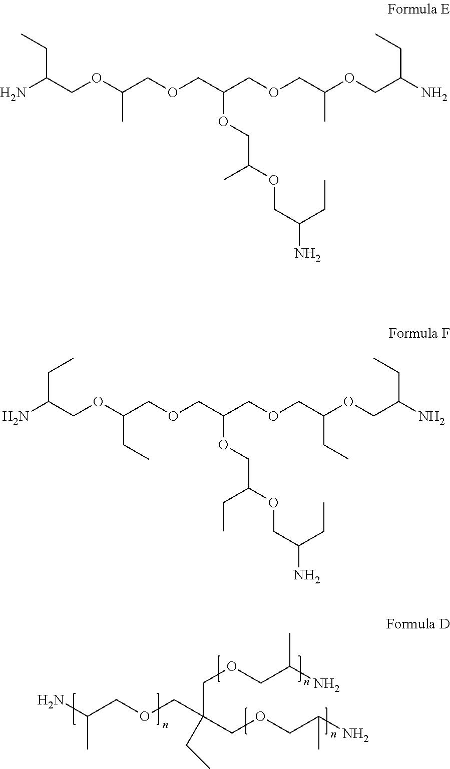

where average n is from about 0.5 to about 5, or about 1 to about 3, or about 1 to about 2.5.

The etheramines of Formula (III) are obtainable by known methods, such as those disclosed in US 2015/0057212A1. The etheramines of Formula (III) may be obtained by a process comprising the following steps:

a) reacting a low-molecular-weight, organic triol, such as glycerine and/or 1,1,1-trimethylolpropane, with C₂-C₁₅ alkylene oxide, to form an alkoxylated triol, where the molar ratio of the low-molecular-weight organic triol to the alkylene oxide is in the range of about 1:3 to about 1:10, and

b) aminating the alkoxylated triol with ammonia.

The low-molecular-weight triol can be selected from glycerine, 1,1,1-trimethylolpropane, or mixtures thereof.

The etheramine of Formula (III) may have a weight average molecular weight of from about 500 to about 1000, or to about 900, or to about 800 grams/mole.

The degree of amination for the etheramine of Formula (III) may be may be from about 67% to about 100%, or from about 85% to about 100%. The degree of amination is calculated as described about in regard to the etheramines of Formula (I) and (II).

The cleaning compositions described herein may contain an etheramine as represented by the structure of Formula (IV):

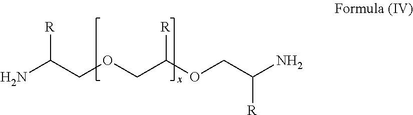

where each R group is independently selected from the group consisting of H, a methyl group, and an ethyl group, where at least one R group is a methyl group, x is in the range of about 2 to about 300. x indicates the average number of repeated units or basic building blocks that constitute the polymer. x may be a whole number or a fraction. x may be in the range of about 2 and about 20, or about 2 to about 10.

The primary amino groups of the etheramine of formula (IV) may be protonated, that is, ammonium groups. The etheramine according to the invention comprises at least one repeated unit based on propylene oxide (R=a methyl group in formula (IV)) in the polymer backbone. The etheramine may have between about 2 and about 10 propylene oxide-based (PO) units. In the mentioned ranges (for the PO units), the hydrophobicity of the etheramine may provide for an improved cleaning on grease and particulate stains.

Suitable etheramines according to the invention are marketed by Huntsman Corp. Texas under the trade names, Jeffamine® D-230, Jeffamine® D-400, Jeffamine® ED-600, and by BASF under the trade names Baxxodur EC301, EC302.

The etheramine may be represented by the structure of Formula (E):

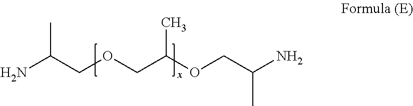

where x is about 2.5.

The etheramine of formula (IV) may have a weight average molecular weight of about 200 to about 1000 grams/mole, or about 230 to about 700 grams/mole, or about 230 to about 450 grams/mole.

The etheramine of Formula (IV) is obtainable by:

a) reacting a propane-1,2-diol of formula (2) with a C₂-C₁₈ alkylene oxide to form an alkoxylated propane-1,2-diol, wherein the molar ratio of propane-1,2-diol to C₂-C₁₈ alkylene oxide is in the range of about 1:2 to about 1:10,

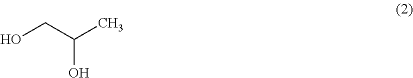

b) aminating the alkoxylated propane-1,2-diol with ammonia.

The degree of amination for the etheramine of Formula (IV) may be from about 50% to about 100%, typically from about 60% to about 100%, and more typically from about 70% to about 100%. The degree of amination is calculated as described about in regard to the etheramines of Formula (I) and (II).

The etheramines of the invention are effective for removal of stains, particularly grease, from soiled material. Detergent compositions containing the etheramines of the invention also do not exhibit the cleaning negatives seen with conventional amine-containing detergent compositions on hydrophilic bleachable stains, such as coffee, tea, wine, or particulates. Additionally, unlike conventional amine-containing detergent compositions, the etheramines of the invention do not contribute to whiteness negatives on white fabrics.

The etheramines of the invention may be used in the form of a water-based, water-containing, or water-free solution, emulsion, gel or paste of the etheramine together with an acid such as, for example, citric acid, lactic acid, sulfuric acid, methanesulfonic acid, hydrogen chloride, e.g., aqeous hydrogen chloride, phosphoric acid, or mixtures thereof. Alternatively, the acid may be represented by a surfactant, such as, alkyl benzene sulphonic acid, alkylsulphonic acid, monoalkyl esters of sulphuric acid, mono alkylethoxy esters of sulphuric acid, fatty acids, alkyl ethoxy carboxylic acids, and the like, or mixtures thereof. When applicable or measurable, the preferred pH of the solution or emulsion ranges from pH 3 to pH 11, or from pH 6 to pH 9.5, even more preferred from pH 7 to pH 8.5.

Cyclic Amines

The cleaning compositions described herein may include a cyclic amine. The cleaning compositions may include from about 0.1% to about 10%, or from about 0.2% to about 5%, or from about 0.5% to about 3%, by weight the composition, of a cyclic amine

The cyclic amine may be represented by the structure of Formula (V):

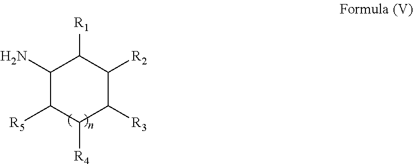

The substituents “Rs” can be independently selected from NH₂, H and linear, branched alkyl or alkenyl from 1 to 10 carbon atoms. For the purpose of this invention “Rs” includes R1-R5. At least one of the “Rs” needs to be NH₂. The remaining “Rs” can be independently selected from NH₂, H and linear, branched alkyl or alkenyl having from 1 to 10 carbon atoms. n is from 0 to 3, or n is 1.

The amine of the disclosure may be a cyclic amine with at least two primary amine functionalities. The primary amines can be in any position in the cycle but it has been found that in terms of grease cleaning, better performance may be obtained when the primary amines are in positions 1,3. It has also been found advantageous in terms of grease cleaning amines in which one of the substituents is —CH3 and the rest are H.

The term “cyclic amine” as used herein encompasses a single cyclic amine and a mixture thereof.

The cyclic amine can be subjected to protonation depending on the pH of the cleaning medium in which it is used.

### Other Adjuncts

The cleaning compositions described herein may include other adjunct components. For example, the cleaning compositions may comprise a surfactant system as described below. The cleaning composition may comprise a fabric shading agent as described below and/or an additional enzyme selected from lipases, nucleases, amylases, proteases, mannanases, pectate lyases, cellulases, cutinases, and mixtures thereof. The cleaning composition may comprise a cleaning cellulase.

The composition may comprise a fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Preferred dyes include alkoxylated azothiophenes, Solvent Violet 13, Acid Violet 50 and Direct Violet 9.

The cleaning compositions described herein may include one or more of the following non-limiting list of ingredients: fabric care benefit agent; detersive enzyme; deposition aid; rheology modifier; builder; chelant; bleach; bleaching agent; bleach precursor; bleach booster; bleach catalyst; encapsulated benefit agents, including where perfume is in the core; perfume; perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors; cationic starches; scum dispersants; substantive dyes; colorants; opacifier; antioxidant; hydrotropes such as toluenesulfonates, cumenesulfonates and naphthalenesulfonates; color speckles; colored beads, spheres or extrudates; clay softening agents; anti-bacterial agents. Additionally, or alternatively, the compositions may comprise surfactants, quaternary ammonium compounds, and/or solvent systems. Quaternary ammonium compounds may be present in fabric enhancer compositions, such as fabric softeners, and comprise quaternary ammonium cations that are positively charged polyatomic ions of the structure NR₄⁺, where R is an alkyl group or an aryl group.

Surfactant System

The cleaning composition may comprise a surfactant system. The cleaning composition may comprise from about 1% to about 80%, or from 1% to about 60%, preferably from about 5% to about 50% more preferably from about 8% to about 40%, by weight of the cleaning composition, of a surfactant system.

Surfactants of the present surfactant system may be derived from natural and/or renewable sources.

The surfactant system may comprise an anionic surfactant, more preferably an anionic surfactant selected from the group consisting of alkyl sulfate, alkyl alkoxy sulfate, especially alkyl ethoxy sulfate, alkyl benzene sulfonate, paraffin sulfonate and mixtures thereof. The surfactant system may further comprise a surfactant selected from the group consisting of nonionic surfactant, cationic surfactant, amphoteric surfactant, zwitterionic surfactant, and mixtures thereof. The surfactant system may comprise an amphoteric surfactant; the amphoteric surfactant may comprise an amine oxide surfactant. The surfactant system may comprise a nonionic surfactant; the nonionic surfactant may comprise an ethoxylated nonionic surfactant.

Alkyl sulfates are preferred for use herein and also alkyl ethoxy sulfates; more preferably a combination of alkyl sulfates and alkyl ethoxy sulfates with a combined average ethoxylation degree of less than 5, preferably less than 3, more preferably less than 2 and more than 0.5 and an average level of branching of from about 5% to about 40%.

The composition of the invention comprises amphoteric and/or zwitterionic surfactant, preferably the amphoteric surfactant comprises an amine oxide, preferably an alkyl dimethyl amine oxide, and the zwitteronic surfactant comprises a betaine surfactant.

The most preferred surfactant system for the detergent composition of the present invention comprise from 1% to 40%, preferably 6% to 35%, more preferably 8% to 30% weight of the total composition of an anionic surfactant, preferably an alkyl alkoxy sulfate surfactant, more preferably an alkyl ethoxy sulfate, combined with 0.5% to 15%, preferably from 1% to 12%, more preferably from 2% to 10% by weight of the composition of amphoteric and/or zwitterionic surfactant, more preferably an amphoteric and even more preferably an amine oxide surfactant, especially and alkyl dimethyl amine oxide. Preferably the composition further comprises a nonionic surfactant, especially an alcohol alkoxylate in particular and alcohol ethoxylate nonionic surfactant.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C22 alkyl, or acyl group. Such surfactants are employed in the form of water-soluble salts and the salt-forming cation usually is selected from sodium, potassium, ammonium, magnesium and mono-, di- or tri-C2-C3 alkanolammonium, with the sodium cation being the usual one chosen.

The anionic surfactant can be a single surfactant but usually it is a mixture of anionic surfactants. Preferably the anionic surfactant comprises a sulfate surfactant, more preferably a sulfate surfactant selected from the group consisting of alkyl sulfate, alkyl alkoxy sulfate and mixtures thereof. Preferred alkyl alkoxy sulfates for use herein are alkyl ethoxy sulfates.

Sulfated Anionic Surfactant

Preferably the sulfated anionic surfactant is alkoxylated, more preferably, an alkoxylated branched sulfated anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the sulfated anionic surfactant is a mixture of sulfated anionic surfactants, the alkoxylation degree is the weight average alkoxylation degree of all the components of the mixture (weight average alkoxylation degree). In the weight average alkoxylation degree calculation the weight of sulfated anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

The branched sulfated anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation, the weight of anionic surfactant components not having branched groups should also be included.

Suitable sulfate surfactants for use herein include water-soluble salts of C8-C18 alkyl or hydroxyalkyl, sulfate and/or ether sulfate. Suitable counterions include alkali metal cation or ammonium or substituted ammonium, but preferably sodium.

The sulfate surfactants may be selected from C8-C18 primary, branched chain and random alkyl sulfates (AS); C8-C18 secondary (2,3) alkyl sulfates; C8-C18 alkyl alkoxy sulfates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulfates include, those based on Neodol alcohols ex the Shell company, Lial-Isalchem and Safol ex the Sasol company, natural alcohols ex The Procter & Gamble Chemicals company.

Preferably, the anionic surfactant comprises at least 50%, more preferably at least 60% and especially at least 70% of a sulfate surfactant by weight of the anionic surfactant. Especially preferred detergents from a cleaning view point are those in which the anionic surfactant comprises more than 50%, more preferably at least 60% and especially at least 70% by weight thereof of sulfate surfactant and the sulfate surfactant is selected from the group consisting of alkyl sulfates, alkyl ethoxy sulfates and mixtures thereof. Even more preferred are those in which the anionic surfactant is an alkyl ethoxy sulfate with a degree of ethoxylation of from about 0.2 to about 3, more preferably from about 0.3 to about 2, even more preferably from about 0.4 to about 1.5, and especially from about 0.4 to about 1. They are also preferred anionic surfactant having a level of branching of from about 5% to about 40%, even more preferably from about 10% to 35% and especially from about 20% to 30%.

Sulfonate Surfactant

Suitable anionic sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also includes the alkyl glyceryl sulfonate surfactants.

Nonionic Surfactant

Nonionic surfactant, when present, is comprised in a typical amount of from 0.1% to 40%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable non-ionic surfactants for use herein include fatty alcohol polyglycol ethers, alkylpolyglucosides and fatty acid glucamides.

Amphoteric Surfactant

The surfactant system may include amphoteric surfactant, such as amine oxide. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide may further comprise two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula (I):

R¹—[CO—X(CH₂)ₙ]ₓ—N⁺(R²)(R₃)—(CH₂)ₘ—[CH(OH)—CH₂]_{y}—Y— (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻ ], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetaine.

### Encapsulated Benefit Agent

The composition may further comprise an encapsulated benefit agent. The encapsulated benefit may comprise a shell surrounding a core. The core may comprise a benefit agent. The benefit agent may comprise perfume raw materials.

The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof.

The shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof.

The core may comprise a benefit agent. Suitable benefit agents include a material selected from the group consisting of perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof. The benefit agent may comprise perfume raw materials.

The composition may comprise, based on total composition weight, from about 0.01% to about 10%, or from about 0.1% to about 5%, or from about 0.2% to about 1%, of encapsulated benefit agent. The encapsulated benefit agent may be friable and/or have a mean particle size of from about 10 microns to about 500 microns or from about 20 microns to about 200 microns.

Suitable encapsulated benefit agents may be obtained from Encapsys, LLC, of Appleton, Wis. USA.

Formaldehyde scavengers may also be used in or with such encapsulated benefit agents.

### Methods of Making the Composition

The present disclosure relates to methods of making the compositions described herein. The compositions of the invention may be solid (for example granules or tablets) or liquid form. Preferably the compositions are in liquid form. They may be made by any process chosen by the formulator, including by a batch process, a continuous loop process, or combinations thereof.

When in the form of a liquid, the compositions of the invention may be aqueous (typically above 2 wt % or even above 5 or 10 wt % total water, up to 90 or up to 80 wt % or 70 wt % total water) or non-aqueous (typically below 2 wt % total water content). Typically, the compositions of the invention will be in the form of an aqueous solution or uniform dispersion or suspension of optical brightener, DTI and optional additional adjunct materials, some of which may normally be in solid form, that have been combined with the normally liquid components of the composition, such as the liquid alcohol ethoxylate nonionic, the aqueous liquid carrier, and any other normally liquid optional ingredients. Such a solution, dispersion or suspension will be acceptably phase stable. When in the form of a liquid, the detergents of the invention preferably have viscosity from 1 to 1500 centipoises (1-1500 mPa*s), more preferably from 100 to 1000 centipoises (100-1000 mPa*s), and most preferably from 200 to 500 centipoises (200-500 mPa*s) at 20 s-1 and 21° C. Viscosity can be determined by conventional methods. Viscosity may be measured using an AR 550 rheometer from TA instruments using a plate steel spindle at 40 mm diameter and a gap size of 500 μm. The high shear viscosity at 20 s-1 and low shear viscosity at 0.05-1 can be obtained from a logarithmic shear rate sweep from 0.1-1 to 25-1 in 3 minutes time at 21 C. The preferred rheology described therein may be achieved using internal existing structuring with detergent ingredients or by employing an external rheology modifier. More preferably the detergents, such as detergent liquid compositions have a high shear rate viscosity of from about 100 centipoise to 1500 centipoise, more preferably from 100 to 1000 cps. Unit Dose detergents, such as detergent liquid compositions have high shear rate viscosity of from 400 to 1000 cps. Detergents such as laundry softening compositions typically have high shear rate viscosity of from 10 to 1000, more preferably from 10 to 800 cps, most preferably from 10 to 500 cps. Hand dishwashing compositions have high shear rate viscosity of from 300 to 4000 cps, more preferably 300 to 1000 cps.

The cleaning and/or treatment compositions in the form of a liquid herein can be prepared by combining the components thereof in any convenient order and by mixing, e.g., agitating, the resulting component combination to form a phase stable liquid detergent composition. In a process for preparing such compositions, a liquid matrix is formed containing at least a major proportion, or even substantially all, of the liquid components, e.g., nonionic surfactant, the non-surface active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of any anionic surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme granulates, are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

The adjunct ingredients in the compositions of this invention may be incorporated into the composition as the product of the synthesis generating such components, either with or without an intermediate purification step. Where there is no purification step, commonly the mixture used will comprise the desired component or mixtures thereof (and percentages given herein relate to the weight percent of the component itself unless otherwise specified) and in addition unreacted starting materials and impurities formed from side reactions and/or incomplete reaction. For example, for an ethoxylated or substituted component, the mixture will likely comprise different degrees of ethoxylation/substitution.

### Method of Use

The present disclosure relates to methods of using the cleaning compositions of the present disclosure to clean a surface, such as a textile. In general, the method includes mixing the cleaning composition as described herein with water to form an aqueous liquor and contacting a surface, preferably a textile, with the aqueous liquor in a laundering step. The target surface may include a greasy soil.

The compositions of this invention, typically prepared as hereinbefore described, can be used to form aqueous washing/treatment solutions for use in the laundering/treatment of fabrics and/or hard surfaces. Generally, an effective amount of such a composition is added to water, for example in a conventional fabric automatic washing machine, to form such aqueous laundering solutions. The aqueous washing solution so formed is then contacted, typically under agitation, with the fabrics to be laundered/treated therewith. An effective amount of the detergent composition herein added to water to form aqueous laundering solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the wash liquor is formed by contacting the detergent with wash water in such an amount so that the concentration of the detergent in the wash liquor is from above 0 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l. The method of laundering fabric or textile may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. Typically, from 0.01 kg to 2 kg of fabric per litre of wash liquor is dosed into said wash liquor. Typically, from 0.01 kg, or from 0.05 kg, or from 0.07 kg, or from 0.10 kg, or from 0.15 kg, or from 0.20 kg, or from 0.25 kg fabric per litre of wash liquor is dosed into said wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1. Typically the wash liquor comprising the detergent of the invention has a pH of from 3 to 11.5.

In one aspect, such method comprises the steps of optionally washing and/or rinsing said surface or fabric, contacting said surface or fabric with any composition disclosed in this specification then optionally washing and/or rinsing said surface or fabric is disclosed, with an optional drying step.

Drying of such surfaces or fabrics may be accomplished by any one of the common means employed either in domestic or industrial settings: machine drying or open-air drying. The fabric may comprise any fabric capable of being laundered in normal consumer or institutional use conditions, and the invention is particularly suitable for synthetic textiles such as polyester and nylon and especially for treatment of mixed fabrics and/or fibres comprising synthetic and cellulosic fabrics and/or fibres. As examples of synthetic fabrics are polyester, nylon, these may be present in mixtures with cellulosic fibres, for example, polycotton fabrics. The solution typically has a pH of from 7 to 11, more usually 8 to 10.5. The compositions are typically employed at concentrations from 500 ppm to 5,000 ppm in solution. The water temperatures typically range from about 5° C. to about 90° C. The water to fabric ratio is typically from about 1:1 to about 30:1.

### Use of Water-Insoluble Plant Fiber

The present disclosure further relates to a use of water-insoluble plant fiber in a cleaning composition to enhance the stain-removal and/or malodor-reducing benefits of an extracellular-polymer-degrading enzyme.

### Use of a Dye Control Agent

The present disclosure further relates to a use of dye control agent in a cleaning composition to enhance the soil-removal, whitening and/or malodor-reducing benefits of an extracellular-polymer-degrading enzyme. The dye control agent may be selected from (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazine monomer compounds; and (vi) combinations thereof.

### Use of an Alkoxylated Phenol

The present disclosure further relates to a use of an alkoxylated polyaryl phenol and/or an alkoxylated polyalkyl phenol in a cleaning composition to enhance the stain-removal, whiteness, and/or malodor-reducing benefits of an extracellular-polymer-degrading enzyme.

### Use of an Acyl Hydrazone Bleach Catalyst

The present disclosure further relates to a use of an acyl hydrazone bleach catalyst as described herein, for example in a cleaning composition, to enhance the stain removal, bleaching, and/or malodor-reducing benefits of an extracellular-polymer-degrading enzyme, typically in the presence of a peroxygen source.

### Use of an Amine

The present disclosure further relates to a use of an amine as described herein, for example in a cleaning composition, to enhance the stain removal, bleaching, and/or malodor-reducing benefits of an extracellular-polymer-degrading enzyme selected from the group consisting of galactanase enzymes, mannanase enzymes, and mixtures thereof.

### Test Methods

### Enzymatic Activity Towards Xyloglucan Substrates

An enzyme is deemed to have activity towards xyloglucan if the pure enzyme has a specific activity of greater than 50000 XyloU/g according to the following assay at pH 7.5.

The xyloglucanase activity is measured using AZCL-xyloglucan from Megazyme, Ireland as substrate (blue substrate).

A solution of 0.2% of the blue substrate is suspended in a 0.1M phosphate buffer pH 7.5, 20° C. under stirring in a 1.5 ml Eppendorf tubes (0.75 ml to each), 50 microlitres enzyme solution is added and they are incubated in an Eppendorf Thermomixer for 20 minutes at 40° C., with a mixing of 1200 rpm. After incubation, the coloured solution is separated from the solid by 4 minutes centrifugation at 14,000 rpm and the absorbance of the supernatant is measured at 600 nm in a 1 cm cuvette using a spectrophotometer. One XyloU unit is defined as the amount of enzyme resulting in an absorbance of 0.24 in a 1 cm cuvette at 600 nm.

Only absorbance values between 0.1 and 0.8 are used to calculate the XyloU activity. If an absorbance value is measured outside this range, optimization of the starting enzyme concentration should be carried out accordingly.

### Enzymatic Activity Towards Amorphous Cellulose Substrates

An enzyme is deemed to have activity towards amorphous cellulose if the pure enzyme has a specific activity of greater than 20000 EBG/g according to the following assay at pH 7.5. Chemicals used as buffers and substrates were commercial products of at least reagent grade. Endoglucanase Activity Assay Materials:
0.1M phosphate buffer pH 7.5
Cellazyme C tablets, supplied by Megazyme International, Ireland.
Glass microfiber filters, GF/C, 9 cm diameter, supplied by Whatman.

### Method:

In test tubes, mix 1 ml pH 7.5 buffer and 5 ml deionised water.

Add 100 microliter of the enzyme sample (or of dilutions of the enzyme sample with known weight:weight dilution factor). Add 1 Cellazyme C tablet into each tube, cap the tubes and mix on a vortex mixer for 10 seconds. Place the tubes in a thermostated water bath, temperature 40° C. After 15, 30 and 45 minutes, mix the contents of the tubes by inverting the tubes, and replace in the water bath. After 60 minutes, mix the contents of the tubes by inversion and then filter through a GF/C filter. Collect the filtrate in a clean tube.

Measure Absorbance (Aenz) at 590 nm, with a spectrophotometer. A blank value, Awater, is determined by adding 100 μl water instead of 100 microliter enzyme dilution.

Calculate Adelta=Aenz−Awater.

Adelta must be <0.5. If higher results are obtained, repeat with a different enzyme dilution factor.

Determine DFO.1, where DFO.1 is the dilution factor needed to give Adelta=0.1. Unit Definition: 1 Endo-Beta-Glucanase activity unit (1 EBG) is the amount of enzyme that gives Adelta=0.10, under the assay conditions specified above. Thus, for example, if a given enzyme sample, after dilution by a dilution factor of 100, gives Adelta=0.10, then the enzyme sample has an activity of 100 EBG/g.

### EXAMPLES

The following are illustrative examples of cleaning compositions according to the present disclosure and are not intended to be limiting.

### Examples 1-7: Heavy Duty Liquid Laundry Detergent Compositions

| | 1 | 2 | 3 | 4 | 5 | 6 | 7 |
|---|---|---|---|---|---|---|---|
| Ingredients | % weight | | | | | | |
| AE_{1.8}S | 6.77 | 5.16 | 1.36 | 1.30 | — | — | — |
| AE₃S | — | — | — | — | 0.45 | — | — |
| LAS | 0.86 | 2.06 | 2.72 | 0.68 | 0.95 | 1.56 | 3.55 |
| HSAS | 1.85 | 2.63 | 1.02 | — | — | — | — |
| AE9 | 6.32 | 9.85 | 10.20 | 7.92 | | | |
| AE8 | | | | | | | 35.45 |
| AE7 | | | | | 8.40 | 12.44 | |
| C₁₂₋₁₄ dimethyl Amine Oxide | 0.30 | 0.73 | 0.23 | 0.37 | — | — | — |
| C₁₂₋₁₈ Fatty Acid | 0.80 | 1.90 | 0.60 | 0.99 | 1.20 | — | 15.00 |
| Citric Acid | 2.50 | 3.96 | 1.88 | 1.98 | 0.90 | 2.50 | 0.60 |
| Optical Brightener 1 | 1.00 | 0.80 | 0.10 | 0.30 | 0.05 | 0.50 | 0.001 |
| Optical Brightener 3 | 0.001 | 0.05 | 0.01 | 0.20 | 0.50 | — | 1.00 |
| Sodium formate | 1.60 | 0.09 | 1.20 | 0.04 | 1.60 | 1.20 | 0.20 |
| DTI 1 | 0.32 | 0.05 | — | 0.60 | 0.10 | 0.60 | 0.01 |
| DTI 2 | 0.32 | 0.10 | 0.60 | 0.60 | 0.05 | 0.40 | 0.20 |
| Sodium hydroxide | 2.30 | 3.80 | 1.70 | 1.90 | 1.70 | 2.50 | 2.30 |
| Monoethanolamine | 1.40 | 1.49 | 1.00 | 0.70 | — | — | — |
| Diethylene glycol | 5.50 | — | 4.10 | — | — | — | — |
| Chelant 1 | 0.15 | 0.15 | 0.11 | 0.07 | 0.50 | 0.11 | 0.80 |
| 4-formyl-phenylboronic acid | — | — | — | — | 0.05 | 0.02 | 0.01 |
| Sodium tetraborate | 1.43 | 1.50 | 1.10 | 0.75 | — | 1.07 | — |
| Ethanol | 1.54 | 1.77 | 1.15 | 0.89 | — | 3.00 | 7.00 |
| Polymer 1 | 0.10 | — | — | — | — | — | 2.00 |
| Polymer 2 | 0.30 | 0.33 | 0.23 | 0.17 | — | — | — |
| Polymer 3 | — | — | — | — | — | — | 0.80 |
| Polymer 4 | 0.80 | 0.81 | 0.60 | 0.40 | 1.00 | 1.00 | — |
| 1,2-Propanediol | — | 6.60 | — | 3.30 | 0.50 | 2.00 | 8.00 |
| Structurant | 0.10 | — | — | — | — | — | 0.10 |
| Perfume | 1.60 | 1.10 | 1.00 | 0.80 | 0.90 | 1.50 | 1.60 |
| Perfume encapsulate | 0.10 | 0.05 | 0.01 | 0.02 | 0.10 | 0.05 | 0.10 |
| Protease | 0.80 | 0.60 | 0.70 | 0.90 | 0.70 | 0.60 | 1.50 |
| Mannanase | 0.07 | 0.05 | 0.045 | 0.06 | 0.04 | 0.045 | 0.10 |
| Amylase 1 | 0.30 | — | 0.30 | 0.10 | — | 0.40 | 0.10 |
| Amylase 2 | — | 0.20 | 0.10 | 0.15 | 0.07 | — | 0.10 |
| Xyloglucannase | 0.20 | 0.10 | — | — | 0.05 | 0.05 | 0.20 |
| Lipase | 0.40 | 0.20 | 0.30 | 0.10 | 0.20 | — | — |
| Polishing enzyme | — | 0.04 | — | — | — | 0.004 | — |
| Extracellular-polymer- | 0.05 | 0.03 | 0.01 | 0.03 | 0.03 | 0.003 | 0.003 |
| degrading enzyme | | | | | | | |
| Dispersin B | — | — | — | 0.05 | 0.03 | 0.001 | 0.001 |
| Acid Violet 50 | 0.05 | — | — | — | — | — | 0.005 |
| Direct Violet 9 | — | — | — | — | — | 0.05 | — |
| Violet DD | — | 0.035 | 0.02 | 0.037 | 0.04 | — | — |
| Water insoluble plant fiber | 0.2 | — | — | — | 1.2 | — | — |
| Dye control agent | — | 0.3 | — | 0.5 | — | 0.3 | — |
| Alkoxylated polyaryl/ | — | — | 1.2 | — | — | — | 3.1 |
| polyalkyl phenol | | | | | | | |
| Acyl hydrazone | — | — | — | — | — | — | — |

| | |
|---|---|
| Water, dyes & minors | Balance |
| pH | 8.2 |

Based on total cleaning and/or treatment composition weight. Enzyme levels are reported as raw material.

### Examples 8 to 18: Unit Dose Compositions

These examples provide various formulations for unit dose laundry detergents. Compositions 8 to 12 comprise a single unit dose compartment. The film used to encapsulate the compositions is polyvinyl alcohol-based film.

| | 8 | 9 | 10 | 11 | 12 |
|---|---|---|---|---|---|
| Ingredients | % weight | | | | |
| LAS | 19.09 | 16.76 | 8.59 | 6.56 | 3.44 |
| AE3S | 1.91 | 0.74 | 0.18 | 0.46 | 0.07 |
| AE7 | 14.00 | 17.50 | 26.33 | 28.08 | 31.59 |
| Citric Acid | 0.6 | 0.6 | 0.6 | 0.6 | 0.6 |
| C12-15 Fatty Acid | 14.8 | 14.8 | 14.8 | 14.8 | 14.8 |
| Polymer 3 | 4.0 | 4.0 | 4.0 | 4.0 | 4.0 |
| Chelant 2 | 1.2 | 1.2 | 1.2 | 1.2 | 1.2 |
| Optical Brightener 1 | 0.20 | 0.25 | 0.01 | 0.01 | 0.50 |
| Optical Brightener 2 | 0.20 | — | 0.25 | 0.03 | 0.01 |
| Optical Brightener 3 | 0.18 | 0.09 | 0.30 | 0.01 | — |
| DTI 1 | 0.10 | — | 0.20 | 0.01 | 0.05 |
| DTI 2 | — | 0.10 | 0.20 | 0.25 | 0.05 |
| Glycerol | 6.1 | 6.1 | 6.1 | 6.1 | 6.1 |
| Monoethanol amine | 8.0 | 8.0 | 8.0 | 8.0 | 8.0 |
| Tri-isopropanol amine | — | — | 2.0 | — | — |
| Tri-ethanol amine | — | 2.0 | — | — | — |
| Cumene sulfonate | — | — | — | — | 2.0 |
| Protease | 0.80 | 0.60 | 0.07 | 1.00 | 1.50 |
| Mannanase | 0.07 | 0.05 | 0.05 | 0.10 | 0.01 |
| Amylase 1 | 0.20 | 0.11 | 0.30 | 0.50 | 0.05 |
| Amylase 2 | 0.11 | 0.20 | 0.10 | — | 0.50 |
| Polishing enzyme | 0.005 | 0.05 | — | — | — |
| Extracellular-polymer- | 0.005 | 0.05 | 0.005 | 0.010 | 0.005 |
| degrading enzyme | | | | | |
| Dispersin B | 0.010 | 0.05 | 0.005 | 0.005 | — |
| Cyclohexyl dimethanol | — | — | — | 2.0 | — |
| Acid violet 50 | 0.03 | 0.02 | | | |
| Violet DD | | | 0.01 | 0.05 | 0.02 |
| Structurant | 0.14 | 0.14 | 0.14 | 0.14 | 0.14 |
| Perfume | 1.9 | 1.9 | 1.9 | 1.9 | 1.9 |
| Water insoluble plant fiber | — | 0.3 | | — | 0.1 |
| Dye control agent | — | — | 0.2 | — | — |
| Alkoxylated polyaryl/ | 0.3 | — | — | 0.9 | — |
| polyalkyl phenol | | | | | |
| Acyl hydrazone | — | — | — | — | — |

| | |
|---|---|
| Water and miscellaneous | To 100% |
| pH | 7.5-8.2 |

Based on total cleaning and/or treatment composition weight. Enzyme levels are reported as raw material.

In the following examples the unit dose has three compartments, but similar compositions can be made with two, four or five compartments. The film used to encapsulate the compartments is polyvinyl alcohol.

| | Base compositions | | | |
|---|---|---|---|---|
| | 13 | 14 | 15 | 16 |
| Ingredients | % weight | | | |
| HLAS | 26.82 | 16.35 | 7.50 | 3.34 |
| AE7 | 17.88 | 16.35 | 22.50 | 30.06 |
| Citric Acid | 0.5 | 0.7 | 0.6 | 0.5 |
| C12-15 Fatty acid | 16.4 | 6.0 | 11.0 | 13.0 |
| Polymer 1 | 2.9 | 0.1 | — | — |
| Polymer 3 | 1.1 | 5.1 | 2.5 | 4.2 |
| Cationic cellulose polymer | — | — | 0.3 | 0.5 |
| Polymer 6 | — | 1.5 | 0.3 | 0.2 |
| Chelant 2 | 1.1 | 2.0 | 0.6 | 1.5 |
| Optical Brightener 1 | 0.20 | 0.25 | 0.01 | 0.005 |
| Optical Brightener 3 | 0.18 | 0.09 | 0.30 | 0.005 |
| DTI 1 | 0.1 | — | 0.2 | — |
| DTI 2 | — | 0.1 | 0.2 | — |
| Glycerol | 5.3 | 5.0 | 5.0 | 4.2 |
| Monoethanolamine | 10.0 | 8.1 | 8.4 | 7.6 |
| Polyethylene glycol | — | — | 2.5 | 3.0 |
| Potassium sulfite | 0.2 | 0.3 | 0.5 | 0.7 |
| Protease | 0.80 | 0.60 | 0.40 | 0.80 |
| Amylase 1 | 0.20 | 0.20 | 0.200 | 0.30 |
| Polishing enzyme | — | — | 0.005 | 0.005 |
| Extracellular-polymer- | 0.05 | 0.010 | 0.005 | 0.005 |
| degrading enzyme | | | | |
| Dispersin B | — | 0.010 | 0.010 | 0.010 |
| MgCl₂ | 0.2 | 0.2 | 0.1 | 0.3 |
| Structurant | 0.2 | 0.1 | 0.2 | 0.2 |
| Acid Violet 50 | 0.04 | 0.03 | 0.05 | 0.03 |
| Perfume/encapsulates | 0.10 | 0.30 | 0.01 | 0.05 |
| Water-insoluble plant fiber | — | — | 0.4 | — |
| Dye control agent | — | 0.6 | — | 1.2 |
| Alkoxylated polyaryl/ | 1.1 | — | — | — |
| polyalkyl phenol | | | | |
| Acyl hydrazone | — | — | — | — |

| | |
|---|---|
| Solvents and misc. | To 100% |
| pH | 7.0-8.2 |

| | Finishing compositions | | | | | |
|---|---|---|---|---|---|---|
| | 17 | | | 18 | | |
| | Compartment | | | | | |
| | A | B | C | A | B | C |
| | Volume of each compartment | | | | | |
| | 40 ml | 5 ml | 5 ml | 40 ml | 5 ml | 5 ml |
| Ingredients | Active material in Wt. % | | | | | |
| Perfume | 1.6 | 1.6 | 1.6 | 1.6 | 1.6 | 1.6 |
| Violet DD | 0 | 0.006 | 0 | 0 | 0.004 | — |
| TiO2 | — | — | 0.1 | — | | 0.1 |
| Sodium Sulfite | 0.4 | 0.4 | 0.4 | 0.3 | 0.3 | 0.3 |
| Polymer 5 | — | | | 2 | — | — |
| Hydrogenated castor oil | 0.14 | 0.14 | 0.14 | 0.14 | 0.14 | 0.14 |

| | |
|---|---|
| Base Composition 13, 14, 15 | Add to 100% |
| or 16 | |

Based on total cleaning and/or treatment composition weight, enzyme levels are reported as raw material.

### Examples 19 to 24: Granular Laundry Detergent Compositions for Hand Washing or Washing Machines, Typically Top-Loading Washing Machines

| | 19 | 20 | 21 | 22 | 23 | 24 |
|---|---|---|---|---|---|---|
| Ingredient | % weight | | | | | |
| LAS | 11.33 | 10.81 | 7.04 | 4.20 | 3.92 | 2.29 |
| Quaternary ammonium | 0.70 | 0.20 | 1.00 | 0.60 | — | — |
| AE3S | 0.51 | 0.49 | 0.32 | — | 0.08 | 0.10 |
| AE7 | 8.36 | 11.50 | 12.54 | 11.20 | 16.00 | 21.51 |
| Sodium Tripolyphosphate | 5.0 | — | 4.0 | 9.0 | 2.0 | — |
| Zeolite A | — | 1.0 | — | 1.0 | 4.0 | 1.0 |
| Sodium silicate 1.6R | 7.0 | 5.0 | 2.0 | 3.0 | 3.0 | 5.0 |
| Sodium carbonate | 20.0 | 17.0 | 23.0 | 14.0 | 14.0 | 16.0 |
| Polyacrylate MW 4500 | 1.0 | 0.6 | 1.0 | 1.0 | 1.5 | 1.0 |
| Polymer 6 | 0.1 | 0.2 | — | — | 0.1 | — |
| Carboxymethyl cellulose | 1.0 | 0.3 | 1.0 | 1.0 | 1.0 | 1.0 |
| Acid Violet 50 | 0.05 | — | 0.02 | — | 0.04 | — |
| Violet DD | — | 0.03 | — | 0.03 | — | 0.03 |
| Protease 2 | 0.10 | 0.10 | 0.10 | 0.10 | — | 0.10 |
| Amylase | 0.03 | — | 0.03 | 0.03 | 0.03 | 0.03 |
| Lipase | 0.03 | 0.07 | 0.30 | 0.10 | 0.07 | 0.40 |
| Polishing enzyme | 0.002 | — | 0.05 | — | 0.02 | — |
| Extracellular-polymer- | 0.001 | 0.001 | 0.01 | 0.05 | 0.002 | 0.02 |
| degrading enzyme | | | | | | |
| Dispersin B | 0.001 | 0.001 | 0.05 | — | 0.001 | — |
| Optical Brightener 1 | 0.200 | 0.001 | 0.300 | 0.650 | 0.050 | 0.001 |
| Optical Brightener 2 | 0.060 | — | 0.650 | 0.180 | 0.200 | 0.060 |
| Optical Brightener 3 | 0.100 | 0.060 | 0.050 | — | 0.030 | 0.300 |
| Chelant 1 | 0.60 | 0.80 | 0.60 | 0.25 | 0.60 | 0.60 |
| DTI 1 | 0.32 | 0.15 | 0.15 | — | 0.10 | 0.10 |
| DTI 2 | 0.32 | 0.15 | 0.30 | 0.30 | 0.10 | 0.20 |
| Sodium Percarbonate | — | 5.2 | 0.1 | — | — | — |
| Sodium Perborate | 4.4 | — | 3.85 | 2.09 | 0.78 | 3.63 |
| Nonanoyloxybenzensulfonate | 1.9 | 0.0 | 1.66 | 0.0 | 0.33 | 0.75 |
| Tetraacetylehtylenediamine | 0.58 | 1.2 | 0.51 | 0.0 | 0.015 | 0.28 |
| Photobleach | 0.0030 | 0.0 | 0.0012 | 0.0030 | 0.0021 | — |
| S-ACMC | 0.1 | 0.0 | 0.0 | 0.0 | 0.06 | 0.0 |
| Water-insoluble plant fiber | — | — | 2.4 | — | — | — |
| Dye control agent | — | — | — | 2.2 | — | — |
| Alkoxylated polyaryl/ | 1.9 | — | — | — | 2.2 | — |
| polyalkyl phenol | | | | | | |
| Acyl hydrazone | — | 0.7 | — | — | — | 0.6 |

| | |
|---|---|
| Sulfate/Moisture | Balance |

### Examples 25-30: Granular Laundry Detergent Compositions Typically for Front-Loading Automatic Washing Machines

| | 25 | 26 | 27 | 28 | 29 | 30 |
|---|---|---|---|---|---|---|
| Ingredient | % weight | | | | | |
| LAS | 6.08 | 5.05 | 4.27 | 3.24 | 2.30 | 1.09 |
| AE3S | — | 0.90 | 0.21 | 0.18 | — | 0.06 |
| AS | 0.34 | — | — | — | — | — |
| AE7 | 4.28 | 5.95 | 6.72 | 7.98 | 9.20 | 10.35 |
| Quaternary ammonium | 0.5 | — | — | 0.3 | — | — |
| Crystalline layered silicate | 4.1 | — | 4.8 | — | — | — |
| Zeolite A | 5.0 | — | 2.0 | — | 2.0 | 2.0 |
| Citric acid | 3.0 | 4.0 | 3.0 | 4.0 | 2.5 | 3.0 |
| Sodium carbonate | 11.0 | 17.0 | 12.0 | 15.0 | 18.0 | 18.0 |
| Sodium silicate 2R | 0.08 | — | 0.11 | — | — | — |
| Optical Brightener 1 | — | 0.25 | 0.05 | 0.01 | 0.10 | 0.02 |
| Optical Brightener 2 | — | — | 0.25 | 0.20 | 0.01 | 0.08 |
| Optical Brightener 3 | — | 0.06 | 0.04 | 0.15 | — | 0.05 |
| DTI 1 | 0.08 | — | 0.04 | — | 0.10 | 0.01 |
| DTI 2 | 0.08 | — | 0.04 | 0.10 | 0.10 | 0.02 |
| Soil release agent | 0.75 | 0.72 | 0.71 | 0.72 | — | — |
| Acrylic/maleic acid copolymer | 1.1 | 3.7 | 1.0 | 3.7 | 2.6 | 3.8 |
| Carboxymethyl cellulose | 0.2 | 1.4 | 0.2 | 1.4 | 1.0 | 0.5 |
| Protease 3 | 0.20 | 0.20 | 0.30 | 0.15 | 0.12 | 0.13 |
| Amylase 3 | 0.20 | 0.15 | 0.20 | 0.30 | 0.15 | 0.15 |
| Lipase | 0.05 | 0.15 | 0.10 | — | — | — |
| Amylase 2 | 0.03 | 0.07 | — | — | 0.05 | 0.05 |
| Cellulase 2 | — | — | — | — | 0.10 | 0.10 |
| Polishing enzyme | 0.003 | 0.005 | 0.020 | — | — | — |
| Extracellular-polymer- | 0.002 | 0.010 | 0.020 | 0.020 | 0.010 | 0.003 |
| degrading enzyme | | | | | | |
| Dispersin B | 0.002 | 0.010 | 0.020 | 0.020 | 0.010 | 0.002 |
| Tetraacetylehtylenediamine | 3.6 | 4.0 | 3.6 | 4.0 | 2.2 | 1.4 |
| Sodium percabonate | 13.0 | 13.2 | 13.0 | 13.2 | 16.0 | 14.0 |
| Chelant 3 | — | 0.2 | — | 0.2 | — | 0.2 |
| Chelant 2 | 0.2 | — | 0.2 | — | 0.2 | 0.2 |
| MgSO₄ | — | 0.42 | — | 0.42 | — | 0.4 |
| Perfume | 0.5 | 0.6 | 0.5 | 0.6 | 0.6 | 0.6 |
| Suds suppressor agglomerate | 0.05 | 0.10 | 0.05 | 0.10 | 0.06 | 0.05 |
| Soap | 0.45 | 0.45 | 0.45 | 0.45 | — | — |
| Acid Violet 50 | 0.04 | — | 0.05 | — | 0.04 | — |
| Violet DD | — | 0.04 | — | 0.05 | — | 0.04 |
| S-ACMC | 0.01 | 0.01 | — | 0.01 | — | — |
| Direct Violet 9 (active) | — | — | 0.0001 | 0.0001 | — | — |
| Water-insoluble plant fiber | 1.23 | — | — | — | — | — |
| Dye control agent | — | 0.1 | — | — | — | — |
| Alkoxylated polyaryl/ | — | — | 0.81 | — | — | — |
| polyalkyl phenol | | | | | | |
| Acyl hydrazone | — | — | — | 0.3 | 0.06 | 0.3 |

| | |
|---|---|
| Sulfate/Water & Miscellaneous | Balance |

Acyl hydrazone Acyl hydrazone in accordance with the present disclosure, for example 4-(2-(2-((2-hydroxyphenylmethyl)methylene)-hydrazinyl)-2-oxoethyl)-4-melhylchloride suppled as Tinocat® LT (BASF)
AE1.8S is C ₁₂₋₁₅ alkyl ethoxy (1.8) sulfate
AE3S is C₁₂₋₁₅ alkyl ethoxy (3) sulfate
AE7 is C₁₂₋₁₃ alcohol ethoxylate, with an average degree of ethoxylation of 7
AE8 is C₁₂₋₁₃ alcohol ethoxylate, with an average degree of ethoxylation of 8
AE9 is C₁₂₋₁₃ alcohol ethoxylate, with an average degree of ethoxylation of 9
Alkoxylated polyaryl/polyalkyl phenol is alkoxylated polyaryl/polyalkyl phenol in accordance with the present disclosure, for example Emulsogen® TS160, Hostapal® BV conc., Sapogenat® T1 10 or Sapogenat® T139, all from Clariant
Amylase 1 is Stainzyme®, 15 mg active/g
Amylase 2 is Natalase®, 29 mg active/g
Amylase 3 is Stainzyme Plus®, 20 mg active/g,
AS is C₁₂₋₁₄ alkylsulfate
Cellulase 2 is Celluclean™, 15.6 mg active/g
Xyloglucanase is Whitezyme®, 20 mg active/g
Chelant 1 is diethylene triamine pentaacetic acid
Chelant 2 is 1 -hydroxyethane 1,1-diphosphonic acid
Chelant 3 is sodium salt of ethylenediamine-N,N′-disuccinic acid, (S,S) isomer (EDDS)
Dispersin B is a glycoside hydrolase, reported as 1000 mg active/g
DTI 1 is poly(4-vinylpyridine-1-oxide) (such as Chromabond S-403E®),
DTI 2 is poly( 1 -vinylpyrrolidone-co-1 -vinylimidazole) (such as Sokalan HP56®).
Dye control agent Dye control agent in accordance with the present disclosure, for example Suparex® O.IN (M1), Nylofixan® P (M2), Nylofixan® PM (M3), or Nylofixan® HF (M4)
HSAS is mid-branched alkyl sulfate as disclosed in U.S. Pat. No. 6,020,303 and U.S. Pat. No.6,060,443
LAS is linear alkylbenzenesulfonate having an average aliphatic carbon chain length C₉-C₁₅ (HLAS is acid form).
Lipase is Lipex®, 18 mg active/g
Mannanase is Mannaway®, 25 mg active/g
Optical Brightener 1 is disodium 4,4′-bis{[4-anilino-6-morpholino-s-triazin-2-yl]-amino}-2,2′-stilbenedisulfonate
Optical Brightener 2 is disodium 4.4′-bis-(2-sulfostyryl)biphenyl (sodium salt)
Optical Brightener 3 is Optiblanc SPL10® from 3V Sigma
Perfume encapsulate is a core-shell melamine formaldehyde perfume microcapsules.
Photobleach is a sulfonated zinc phthalocyanine
Polishing enzyme is Para-nitrobenzyl esterase, reported as 1000 mg active/g
Polymer 1 is bis((C₂H₅O)(C₂H₄)n)(CH₃)-N⁺-CₓH₂ₓ-N⁺-CH₃)-bis((C₂H₅O)(C₂H₄O)n), wherein n=20−30,x=3 to 8 or sulphated or sulfonated variants thereof
Polymer 2 is ethoxylated (EO₁₅) tetraethylene pentamine
Polymer 3 is ethoxylated polyethylenimine
Polymer 4 is ethoxylated hexamethylene diamine, Baxxodur® ECX 210 from BASF SE, Baxxodur® EC 301 from BASF SE, or a polyetheramine comprising 1 mol 2-butyl-2-ethyl- 1,3-propanediol+5.0 mole propylene oxide, aminated.
Polymer 5 is Acusol 305, provided by Rohm&Haas
Polymer 6 is a polyethylene glycol polymer grafted with vinyl acetate side chains, provided by BASF.
Protease is Purafect Prime®, 40.6 mg active/g
Protease 2 is Savinase®, 32.89 mg active/g
Protease 3 is Purafect®, 84 mg active/g
Quaternary ammonium is C₁₂₋₁₄ Dimethylhydroxyethyl ammonium chloride
S-ACMC is Reactive Blue 19 Azo-CM-Cellulose provided by Megazyme
Soil release agent is Repel-o-tex® SF2
Structurant is Hydrogenated Castor Oil
Violet DD is a thiophene azo dye provided by Milliken
Water insoluble plant fiber is water insoluble plant fiber in accordance with the present disclosure, for example Herbacel AQ+ Type N, supplied by Herbafood Ingredients GmbH, Werder, Germany.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
an extracellular-polymer-degrading enzyme selected from the group consisting of endo-beta-1,6-galactanase enzymes, mannanase enzymes comprising a polypeptide having mannan endo-1,4-beta-mannosidase activity (EC 3.2.1.78) that catalyzes the hydrolysis of 1,4-3-D-mannosidic linkages in mannans, galactomannans and/or glucomannans, and mixtures thereof;
an adjunct material selected from the group consisting of:
a. from about 0.01% to about 5%, by weight of the cleaning composition, of water-insoluble plant fiber;
b. a dye control agent selected from the group consisting of:
(i) a sulfonated phenol/formaldehyde polymer;
(ii) a urea derivative;
(iii) polymers of ethylenically unsaturated monomers, where the polymers are molecularly imprinted with dye;
(iv) fibers consisting of water-insoluble polyamide, wherein the fibers have an average diameter of not more than about 2 μm;
(v) a polymer obtainable from polymerizing benzoxazine monomer compounds; and
(vi) combinations thereof;
c. an alkoxylated phenol compound selected from the group consisting of an alkoxylated polyaryl phenol compound, an alkoxylated polyalkyl phenol compound, and mixtures thereof;
d. a peroxygen source and an acyl hydrazone bleach catalyst;
e. an amine; and
f. mixtures thereof.

2. A cleaning composition according to claim 1, wherein the galactanase enzyme has an amino acid sequence having at least 60%, or at least 80%, or at least 90% or at least 95% identity with the amino acid sequence shown in SEQ ID NO:1, SEQ ID NO:2 or SEQ ID NO:3.

3. A cleaning composition according to claim 1 according to claim 1, wherein the galactanase enzyme is selected from Glycoside Hydrolase Family 30.

4. A cleaning composition according to claim 1, wherein the galactanase enzyme is obtainable from Streptomyces davawensis, Trichoderma harzianum, Streptomyces avermitilis, or a mixture thereof.

5. A cleaning composition according to claim 1, wherein the composition further comprises a β N-acetylglucosaminidase enzyme from E.C. 3.2.1.52, preferably an enzyme having at least 70% identity to SEQ ID NO:9.

6. A cleaning composition according to claim 1, wherein the composition comprises water-insoluble plant fiber.

7. A cleaning composition according to claim 6, wherein the water-insoluble fiber is derived from wood, chicory root, sugar beet, fruit, or a combination thereof.

8. A cleaning composition according to claim 6, wherein the water-insoluble plant fiber comprises particulate cellulose material having a volume-weighted median major particle dimension of from about 25 μm to about 75 μm, as measured by laser light diffractometry.

9. A cleaning composition according to claim 1, wherein the composition comprises a dye control agent selected from (i)-(vi).

10. A cleaning composition according to claim 1, wherein the composition comprises alkoxylated phenol compound.

11. A cleaning composition according to claim 1, wherein the alkoxylated phenol compound has a weight average molecular weight between 280 and 2880.

12. A cleaning composition according to claim 1, wherein the composition comprises the peroxygen source and the acyl hydrazone bleach catalyst.

13. A cleaning composition according to claim 1, wherein the peroxygen source is H₂O₂ or a substance that releases H₂O₂ in water.

14. A cleaning composition according to claim 12, wherein the acyl hydrazone bleach catalyst has a structure according to the formula below: 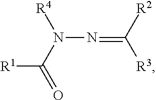
wherein R¹ stands for a CF₃ or for a C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group,
R² and R³ independently of one another stand for hydrogen or an optionally substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group or R² and R³ together with the carbon atom linking them stand for an optionally substituted 5-, 6-, 7-, 8- or 9-membered ring that can optionally comprise heteroatoms, and
R⁴ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group.

15. A cleaning composition according to claim 1, wherein the cleaning composition further comprises from about 1% to about 80%, by weight of the cleaning composition, of a surfactant system.

16. A cleaning composition according to claim 15, wherein the surfactant system comprises an anionic surfactant.

17. A cleaning composition according to claim 1, wherein the composition further comprises fabric shading agent and/or an additional enzyme selected from lipases, amylases, proteases, mannanases, pectate lyases, cellulases, cutinases, and mixtures thereof.

18. A cleaning composition according to claim 1, wherein the composition further comprises an encapsulated benefit agent, wherein the encapsulated benefit agent comprises a shell surrounding a core, the core comprising a benefit agent, preferably the benefit agent comprising perfume raw materials.

19. A cleaning composition according to claim 1, wherein the mannanase enzyme has an amino acid sequence having at least 65%, or at least 80%, or at least 90% or at least 95% identity with the amino acid sequence shown in SEQ ID NO:4, or the enzyme has an amino acid sequence having at least 85%, or at least 90%, or at least 95% or at least 97% identity with the amino acid sequence shown in SEQ ID NO:5.

20. A cleaning composition according to claim 1, wherein the mannanase enzyme is a member of glycoside hydrolase family 26.


SEQUENCE LISTING (9 sequences)

SEQ ID NO: 1 - protein, 463 aa, Streptomyces davawensis
DATIVINPGTRYGTWEGWGTSLAWWGNVFGTRDDFADLFFTTKSVTYNGTSLPGLGLNIARYNLGACSWNAVNGETMVKSPNIPAFKQIEGFWQDWNNEDPTSSAWDWTADATQRAMLVKATQRGAVTELFANSPMWWMCYNHNPSGAADGGNNLQTWNYRQHASHLAAVALYARTNWGVNFATVDPFNEPASSWWTASGTQEGCHLDPAVQAAVLPYMRSELDKRGLTGVRISASDETNYDTARSTWSSFGSATKALVSQVNVHGYQGTGGRRDLLYTDVVTTSGKKLWNSETGDSDGTGLSMARNLCYDFRWLHPTAWCYWQVMDPSTGWAMIAYDANTLQPTTVQPKYYVMAQFSRHIRPGMTILDTGVSFAAAAYDASARRLVLVAVNTSTSPQTFTFDLSRFTTVTGGSGGLVPRWNTVTGGGDMYRAYTNTYVTGKSVSATFAAGSVQTLQVDGVTT

SEQ ID NO: 2 - protein, 464 aa, Streptomyces avermitilis
DATIAVNPSTTYGKWEGWGTSLAWWANVFGARDDFADLFFTTKSVTYNGRTLPGLGLNIARYNLGACSWNSVSGESMVASANIPAFKQIEGYWQDWNNEDPTSSAWKWTADAAQRTMLVKATARGATTELFANSPMWWMCLNHNPSGASGGGNNLQSWNYRQHASHLAAVALYAKSNWGVNFATVDPFNEPSSSWWTATGTQEGCHMDASVQAAVLPYLRSELDRRGLTGTKISASDETSYDLARTTWGSFGSSTKALVNRVNVHGYQGSGGRRDLLYTDVVTTAGKALWNSETGDSDGTGLTLASNLCLDFRWLHPTAWVYWQVMDPSSGWAMIAYDASTLQPGAVQTKYYVMAQFSRHIRAGMTIVDTGVGYAAAAYDATARRLVIVAVNTSTSAQTLTFDLSRFSTVTGGTGGLVRRWNTVTGGGGDLYAAHSDTYLSGKSLSVPFAAGAVQTLEVDGVTV

SEQ ID NO: 3 - protein, 458 aa, Trichoderma harzianum
DTTLSIDPTSNWGTWEGWGVSLAWWAKAFGNRDDLANVFFTRNNQVINGQNLPGLGFNIARYNAGACSTNTYNGSSMVVSSSIKPSRQVDGYWLDWASTDPASSSWNWNVDANQRAMLQKAKANGANIFELFSNSPMWWMCLNHNPSGSGSSDNLQSWNYQNHAVYLANIAQHAQQNWGIQFQSVEAFNEPSSGWGPTGTQEGCHFAVSTMATVIGYLNTELAQRGLSSFISASDETSYDLAISTWQGLGSSAQNAVKRVNVHGYQGGGGRRDTLYSLVSQAGKRLWNSEYGDADASGKSMYTNLLLDFTWLHPTAWVYWQAIDGSGWGLIVGDNDQLTLSSASTKYFVLAQLTRHIRPGMQILTTPDGNTVAAYDSGSQKLVIVAANWGSAQTITFDLTRAKTAGSNGATVPRWSTQTSGGDQYKSYSDTKINNGKFSVSFSTGQVQTFEISGVVLK

SEQ ID NO: 4 - protein, 361 aa, Aggregatibacter actinomycetemcomitans
NCCVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 5 - protein, 541 aa, Ascobolus stictoideus
QTYTLEAEAGTLTGVTVMNEIAGFSGTGYVGGWDEDADTVSLTFTSDATKLYDVKIRYSGPYGSKYTRISYNGATGGDISLPETTEWATVNAGQALLNAGSNTIKLHNNWGWYLIDAVILTPSVPRPPHQVTDALVNTNSNAVTKQLMKFLVSKYHKAYITGQQELHAHQWVEKNVGKSPAILGLDFMDYSPSRVEFGTTSQAVEQAIDFDKRGGIVTFAWHWNAPSGLINTPGSEWWRGFYTEHTTFDVAAALQNTTNANYNLLIRDIDAIAVQLKRLQTAGVPVLWRPLHEAEGGWFWWGAKGPEPAKKLYKILYDRLTNYHKLNNLIWVWNSVAKDWYPGDEIVDVLSFDSYPAQPGDHGPVSAQYNALVELGKDKKLIAATEVGTIPDPDLMQLYESYWSFFVTWEGEFIENGVHNSLEFLKKLYNNSFVLNLDTIQGWKNGAGSSTTTVKSTTTTPTTTIKSTTTTPVTTPTTVKTTTTPTTTATTVKSTTTTAGPTPTAVAGRWQQCGGIGFTGPTTCEAGTTCNVLNPYYSQCL

SEQ ID NO: 6 - protein, 526 aa, Chaetomium virescens
PRDPGATARTFEAEDATLAGTNVDTALSGFTGTGYVTGFDQAADKVTFTVDSASTELYDLSIRVAAIYGDKRTSVVLNGGASSEVYFPAGETWTNVAAGQLLLNQGSNTIDIVSNWGWYLIDSITLTPSTPRPAHQINEAPVNAAADKNAKALYSYLRSIYGKKILSGQQELSLSNWIAQQTGKTPALVSVDLMDYSPSRVERGTVGTAVEEAIQHHNRGGIVSVLWHWNAPTGLYDTEEHRWWSGFYTSATDFDVAAALSSTTNANYTLLIRDIDAIAVQLKRLQSAGVPVLFRPLHEAEGGWFWWGAKGPEPAKKLWGILYDRVTNHHQINNLLWVWNSILPEWYPGDATVDILSADVYAQGNGPMSTQYNQLIELGKDKKMIAAAEVGAAPLPDLLQAYEAHWLWFTVWGDSFINNADWNSLDTLKKVYTSDYVLTLDEIQGWQGSTPSATTTSSTTTPSATTTTTTPSTTATTATPSATTTASPVTYAEHWGQCAGKGWTGPTTCRPPYTCKYQNDWYSQCL

SEQ ID NO: 7 - protein, 452 aa, Preussia aemulans
QTVIYQAEQAKLSGVTVEFSIIKQVVGTGYVEGFDESTDSITFTVESTTAALYDLALTYNGPYGDKYTNVVLNNAAGSQVSLPATTAWTTVPAGQVLLNAGANTIQIQNNWGWYLVDSISLKPAATRGAHQITTKPVNKNANSDAKALLKYLGSIYGKKILSGQQDLSSLDWVTKNVGKTPAVLGLDTMDYSESRKSRGAVSTDVDKAIAFAKKGGIVTFCWHWGAPTGLFDSAAQPWYRGFYTDATDFNIETALKDTTNANYTLLMKDIDTIAVQLKKLQDAGVPVIWRPLHEAEGGWFWWGAKGPEPAKKLWKIMYDRLTNQHGLNNLVWTWNSVAPNWYPGDDTVDIVSADTYSQGDHGPISATYNNLLALTNDTKIIAAAEIGSVMEPAQLQAYQADWVYFCVWSGEFIDGGVWNSLDFLKKVYNDPYVLTLDEIQGWKTARGKPRVS

SEQ ID NO: 8 - protein, 312 aa, Yunnania penicillata
APSTTPVNEKATDAAKNLLSYLVEQAANGVTLSGQQDLESAQWVSDNVGKWPAILGIDFMDYSPSRVEYGAVGSTVPDAISYDSDGGIVTFCWHWGSPSGTYNTTDQPWWSNFYTEATAFDIAAAMDDPDSADYNLLVRDIDAISELLLQLQDLDIPILWRPLHEAEGGWFWWGAKGPEACIALYRLMFDRMTNHHGLNNLLWVWNSVDPSWYPGNDVVDIVSADIYADAGDHSPQEETFASLQSLTGDTKLVALGEVGNIPDPASTGGVADWAYWVTWNGDFIKGEDYNPLEYKKEVFSAENIITRDEVDV

SEQ ID NO: 9 - protein, 327 aa, Myrothecium roridum
GTIENRQWLTYNPVDSAATTEARALLRYIQSQYGWRYLSGQQERAEVQWLKSNIGKTPAIQGSDLIDYSPSRVSYGATSTAVEDAIAFDRQGGIVTFTWHWNAPNCLYNSADQPWYFGFYTKATCFNIQAALAQGSNGADYKLLIRDIDAIAVQLKRLRDAKVPILFRPLHEPDGAWFWWGAKGSGPFKQLWDILYDRLTKYHGLHNMLWVCNTEKSDWYPGNNKCDIATTDVYVNAGDHSVQKSHWDALYGVSGGQRILALGEVGVIPDPERQASENVPWAYWMTWNGYFIRDGNYNSRNFLQSTFSNARVVTLDGTSPLGNWKSS